(19) United States
(12) Patent Application Publication
(10) Pub. No.: US 2013/0092846 A1
(43) Pub. Date: Apr. 18, 2013

(54) FIBER-OPTIC SENSORS FOR REAL-TIME MONITORING

(71) Applicant: UWM RESEARCH FOUNDATION, INC., Milwaukee, WI (US)

(72) Inventors: Paul Henning, New Berlin, WI (US); Peter Geissinger, Shorewood, WI (US); Steven Kopitzke, Greenfield, WI (US); John Frost, Aurora, CO (US)

(73) Assignee: UWM RESEARCH FOUNDATION, INC., Milwaukee, WI (US)

(21) Appl. No.: 13/655,262

(22) Filed: Oct. 18, 2012

Related U.S. Application Data
(60) Provisional application No. 61/548,642, filed on Oct. 18, 2011.

(51) Int. Cl. G01N 21/64

(52) U.S. Cl. 250/458.1; 250/564

(57) ABSTRACT

Described herein are apparatuses for detecting an analyte in a liquid sample using optical time of flight spectroscopy. A handheld apparatus for remote real-time detection of Zn²⁺ in aqueous environments and methods for making and using the apparatus are also described herein.

### RELATED APPLICATIONS

The present application claims priority to U.S. Provisional Application 61/548,642, filed Oct. 18, 2011, the entire contents of which is hereby incorporated by reference.

### BACKGROUND

Real-time monitoring of environmental and industrial waters for pollutants of concern for public and environmental health via the standard method of sampling followed by laboratory analysis is prohibitive. One pollutant class of concern is toxic metals, which enter environmental waters, e.g., through industrial wastewater, from landfills, mine runoffs, and inappropriate waste disposal. Thus, these substances are widely distributed in the environment and may enter the food chain. The observed bioaccumulation of such pollutants in biological systems further increases the threat posed to public health.

The lack of cost-effective real-time monitoring methods prohibits timely detection of harmful substances and conditions. Not only does this pose a serious and immediate threat to public health, it may, as a consequence, lead to long-term costs for treatment and remediation, which may have to be borne by the taxpayer. Thus, efforts for early detection and preventive measures offer incalculable benefits to the public well-being and to the environment, which is why there is a critical need for a corresponding monitoring effort to provide early warning of threats and to enforce regulatory compliance of harmful substance concentrations found in and released into the environment. This requires sensors that allow for real-time, remote monitoring with response times corresponding to the dynamics of the analyte of interest, and with detection limits reflecting the threat potential of monitored substances. This need cannot be met by sampling and transport to a laboratory, which is too expensive and too time-consuming for capturing dynamics and spatial distribution of the target analytes, especially in high-risk areas.

Lack of real-time information in industrial chemical process monitoring may lead to inefficiencies in these processes, such as excessive reagent use, increased waste treatment and disposal costs. Moreover, lack of real-time information will prevent capturing information on the effects of episodic events (e.g. catastrophic device failure in automated processes, spills, illegal discharges) immediately as they occur.

The luminescence properties of molecules and the modification of these properties when the molecular environment changes and/or when other molecular species are present in close proximity have been the subject of intense research for many decades. Understanding these properties is essential for fabrication of a luminescent sensor, where the luminescence properties of molecules change in response to a sensing event. Optical fibers offer an ideal platform for sensing applications using luminescent sensors. Light sources and detectors and their associated signal processing electronics are located far from the measurement site, which facilitates sensing in inhospitable environments. By locating luminescent sensor molecules in the cladding of optical fibers, these serve both as a sensing platform and as a signal transmission conduit. Interaction between light propagating in the fiber core and the sensors located in the fiber cladding occurs through evanescent fields in two steps, i.e. evanescent excitation triggers sensor luminescence, which is captured by evanescent fields and guided to the fiber ends. Many sensors regions can be prepared along a single fiber (quasi-distributed sensing); spatially resolved read-out is achieved using pulsed laser excitation and time-resolved detection [Kvasnik and McGrath, 1989; Browne et al., 1996]. This technique is referred to as Optical Time-of-Flight (OTOF) detection [Potyrailo and Hieftje, 1998]. The response of a luminescent sensor molecule can be a change of luminescence intensity, luminescence wavelength, and/or luminescence lifetime [Lieberman et al., 1990; Demas and DeGraff, 1992; Lippitsch et al., 1992; Anzenbacher et al., 2002]. Adjacent sensor regions must be spaced meters apart. We introduced a new optical fiber sensor architecture that allows for increasing the spatial resolution by several orders of magnitude [Prince et al., 2001a; Prince et al., 2001b]. U.S. Pat. No. 7,244,572, incorporated herein by reference in its entirety, is based on locating the sensors preferably, but not limited to, orthogonally oriented junctions of two optical fibers; following evanescent excitation through one fiber (the “excitation fiber”), the sensor luminescence is captured by the second fiber (the “detection fiber”)—again through evanescent fields—and guided to the detector.

A critical need exists for a monitoring system to provide early warning of threats and to enforce regulatory compliance. This need cannot be met by sampling and transport to the laboratory. Accordingly, a need exists for a handheld apparatus for detecting an analyte in a liquid. Achieving a handheld apparatus has many significant technological challenges, as the prior art contains laboratory-based solutions which require extremely heavy equipment such as lasers, optical tables, oscilloscopes, and the like.

A need exists to provide an optical time of flight sensor array capable of being immersed in a liquid without the need to manually sample the liquid. Accordingly, a need exists to provide an optical time of flight sensor array capable of being moved independently with respect to a light source and detector. Achieving this need contains many significant technological challenges. One such challenge includes engineering a stem capable of retaining optical coupling between a sensor array and both a light source and detector, while allowing independent orientation for the array relative to the light source and detector. Another such challenge includes engineering an optical time of flight sensor array wherein the junctions are capable of fitting within a housing of a certain size wherein liquid can freely come into contact with each junction and any analyte can freely diffuse to and from each junction upon immersion.

A need exists to provide a sensor element capable of being disconnected and reconnected to a control unit. Accordingly, a need exists to provide a sensor element with a means of reproducibly optically coupling the sensor element with both the light source and the detector. Achieving this reproducible connection has many significant technological challenges, as the prior art typically uses stable lasers and detectors, which are tied down to specific locations on an optical table, and couples light using optics that are stabilized on that same optical table.

A need exists to improve on the prior art design to allow for replacement of expensive and extremely heavy pulsed lasers and fast oscilloscopes with inexpensive and lightweight electronics designed to assume these functions, which could result in potential cost reductions by a factor of at least 10 and massive reductions in weight to allow the apparatus to be handheld.

This invention aims to meet these needs by the means disclosed herein.

### SUMMARY

This invention relates to the real-time, remote monitoring of analyte concentrations in liquid environments. This invention also relates to the real-time, remote monitoring of metal ion concentrations in aqueous environments. An optical fiber-based sensor for remotely monitoring zinc concentrations with a detection limit in the parts per billion is disclosed herein, and methods for construction and use thereof.

This disclosure provides a sensor element for determining the concentration of an analyte in a liquid suspected of containing said analyte comprising: an optical time of flight sensor array; a stem; and a control interface, wherein the optical time of flight sensor array comprises a first waveguide comprising an excitation terminus located at a first end of the first waveguide, a second waveguide comprising a signal terminus located at a first end of the second waveguide, and at least one junction, wherein at least one junction is a probe junction comprising a probe polymer and a probe compound, wherein said probe compound is a luminescent compound that produces a first optical signal in the absence of the analyte and a second optical signal in the presence of the analyte, wherein said first optical signal and second optical signal have different peak signal intensity, different integrated signal intensity, different signal decay rate, different signal wavelength, or a combination thereof, wherein the stem is connected to the control interface via a control end and to the optical time of flight sensor array via an array end, and wherein the control interface comprises an excitation control interface and a signal control interface.

This disclosure also provides an apparatus for determining the concentration of an analyte in a liquid suspecting of containing the analyte comprising: an optical time of flight sensor array; a light source; a detector; and a signal processing device, wherein the optical time of flight sensor array comprises a first waveguide comprising an excitation terminus located at a first end of the first waveguide, a second waveguide comprising a signal terminus located at a first end of the second waveguide, and at least one junction, wherein at least one junction is a probe junction comprising a probe polymer and a probe compound, wherein said probe compound is a luminescent compound that produces a first optical signal in the absence of the analyte and a second optical signal in the presence of the analyte, wherein said first optical signal and second optical signal have different peak signal intensity, different integrated signal intensity, different signal decay rate, different signal wavelength, or a combination thereof, wherein the light source, the detector and the signal processing device are electronically coupled, wherein the light source and the excitation terminus are optically coupled, and wherein the detector and the signal terminus are optically coupled.

In some embodiments, the sensor element may further comprise a waveguide retaining plate, wherein the waveguide retaining plate restricts movement of the first and second waveguide relative to one another at each junction. In some embodiment, the array may further comprise from 2 to 1,000,000 junctions.

In some embodiments, the analyte is selected from the group consisting of metal ions, non-metal ions, electrically neutral species, chemical compounds, proteins, sugars, lipids, amines, aromatic compounds, opiates, alcohols, polynucleotides, biological and chemical warfare agents, and combinations thereof. In some embodiments, the analyte is selected from the group consisting of zinc, mercury, cadmium, chromium, copper, silver, aluminum, cobalt, iron, magnesium, manganese, nickel, lead, gold, arsenic, tin, barium, sulfur, strontium, nitrate, perchlorate, phosphates, sulfates, halides, and combinations thereof.

In some embodiments, the probe compound is selected from the group consisting of luminescent chromophores, quantum dots, nanoparticles, nanostructures, and combinations thereof. In some embodiments, the probe compound comprises a probe compound signal time of from about 1 ps to about 1 ms, a probe compound recovery time of from about 1 ps to about 1 s, or a probe compound detection time of from about 1 ms to about 20 minutes.

In some embodiments, probe polymer is a porous polymer. In some embodiments, the probe polymer comprises a poly(ethylene)glycol diacrylate polymer (PEGDA).

In some embodiments, at least one junction adjacent to said probe junction may be a reference junction comprising a reference polymer and a reference compound, wherein the reference junction is located on the first waveguide within 1 m of the probe junction, and wherein the reference compound may be a luminescent compound that produces a reference optical signal having a peak signal intensity, an integrated signal intensity, a signal decay rate, or a combination thereof that varies with respect to an excitation radiation intensity at said probe junction and that remains unchanged in the presence or absence of the analyte. In some embodiments, the reference compound comprises a reference compound signal time of from about 1 ps to about 1 ms, a reference compound recovery time of from about 1 ps to about 1 s, or a reference compound detection time of from about 1 ms to about 20 minutes. In some embodiments, the reference compound is selected from the group consisting of luminescent chromophores, microspheres containing luminescent chromophores, nanoparticles, and combinations thereof. In some embodiments, the reference compound comprises rhodamine-110.

In some embodiments, the reference polymer is a sufficiently nonporous polymer. In some embodiments, the reference polymer is selected from the group consisting of polystyrene, polyacrylonitrile, PEGDA with sufficient crosslink density, and combinations thereof.

In some embodiments, the array comprises a first junction located on the first waveguide proximate the excitation terminus relative to any other junctions and a last junction located on the first waveguide distal the excitation terminus relative to any other junctions. In some embodiments, the first junction is located on the second waveguide proximate the signal terminus relative to any other junctions. In some embodiments, an optical time of flight from the first junction to the last junction along the first waveguide plus an optical time of flight from the last junction to the first junction along the second waveguide is less than or equal to about 1 s. In some embodiments, an optical time of flight between any two adjacent junctions along the first waveguide plus an optical time of flight between said junctions along the second waveguide is greater than about 500 fs.

In some embodiments, the first junction is located on the second waveguide distal the signal terminus relative to other junctions. In some embodiments, the longer of an optical time of flight from the first junction to the last junction along the first waveguide and an optical time of flight from the first junction to the last junction along the second waveguide is greater than about 500 ms. In some embodiments, the longer of an optical time of flight between two adjacent junctions along the first waveguide and an optical time of flight between said junctions along the second waveguide is greater than about 500 ms.

In some embodiments, the junctions of the optical time of flight sensor array are adapted to fit within a housing having a maximum spatial dimensions of about 50 cm×50 cm×50 cm, wherein the junctions can be immersed in a standing body of the liquid, the liquid can come into contact with each junction, and the analyte can diffuse to and from each junction.

In some embodiments, the stem is from about 1 μm to about 100 km in length and allows independent orientation for the optical time of flight sensor array relative to the control interface, and wherein the stem is adapted to provide optical coupling between the excitation control interface and the excitation terminus and between the signal control interface and the signal terminus. In some embodiments, the stem is adapted to provide optical coupling between the light source and the excitation terminus and between the signal terminus and the detector. In some embodiments, the stem is adapted to conduct radiation with a loss of intensity of less than about 99.9%, or wherein the stem is adapted to conduct radiation with a pulse broadening of less than about 1000% as measured by full-width at half-maximum of an intensity profile.

In some embodiments, the excitation radiation interface and signal radiation interface comprise a means of reducing reflections. In some embodiments, the control interface is adapted to reproducibly orient the excitation radiation interface and the signal radiation interface in fixed positions. In some embodiments, the sensor element is adapted to be used as a dip probe. In some embodiments, the apparatus is adapted to be used as a dip probe.

This disclosure also provides an apparatus for determining the concentration of an analyte in a liquid suspected of containing said analyte comprising: a sensor element according to this disclosure, and a control unit comprising a light source; a detector; a signal processing device; and a sensor interface, wherein the light source emits a pulsed electromagnetic radiation suitable for use in optical time of flight spectroscopy, wherein the light source, the detector and the signal processing device are electronically coupled, wherein the sensor interface comprises an excitation sensor interface and a signal sensor interface, wherein the light source and the excitation sensor interface are optically coupled, and wherein the detector and the signal sensor interface are optically coupled.

In some embodiments, wherein the pulsed electromagnetic radiation has an average wavelength from about 300 nm to about 2000 nm, an average full duration at half maximum pulse duration from about 1 fs to about 100 ns, and a repetition rate from about 1 Hz to about 100 MHz.

In some embodiments, the light source comprises a pulsed light-emitting diode, a pulsed laser, a pulsed lamp, a pulsed laser diode, or a pulsed microchip laser.

In some embodiments, the detector is capable of detecting optical time of flight spectroscopy signals. In some embodiments, the detector is capable of single photon detection and has a response time of less than about 50 ns. In some embodiments, the detector is selected from the group consisting of photomultiplier tube, hybrid photomultiplier tube, charge-coupled device, avalanche photodiode, multi-channel plate, photodiode arrays, and combinations thereof. In some embodiments, the detector comprises a photomultiplier tube. In some embodiments, the photomultiplier tube produces a photocurrent pulse, the light source comprises a light source trigger input, and the signal processing device comprises a fast data acquisition circuit. In some embodiments, the fast data acquisition circuit comprises a time-gated integrator circuit.

In some embodiments, the signal processing device is adapted to determine a peak signal intensity, an integrated signal intensity, a signal decay rate, signal wavelength, or a combination thereof. In some embodiments, the signal processing device comprises time-correlated single photon counting or stroboscopic detection methods. In some embodiments, the apparatus further comprises a user input, a display, a means of compensating for chirp, or a wavelength selector.

In some embodiments, the apparatus is adapted to be handheld.

### BRIEF DESCRIPTION OF THE DRAWINGS

FIG. 1 shows in-lab optical setups for performing optical time of flight spectroscopy. FIG. 1(a) shows a single detector setup. FIG. 1(b) shows a double detector setup used in Example 1. FIG. 1(c) shows the optical setup used in Example 2.

FIGS. 2(a) and 2(b) show a handheld embodiment of apparatus of the present invention shown without the optical time of flight sensor array. FIG. 2(a) is the external view. FIG. 2(b) is the internal view.

FIG. 3 shows one dip-probe embodiment of the optical time of flight sensor array.

FIG. 4 shows the chemical structure for two probe compounds: a CadmIon compound shown in FIG. 4(a) and a MercurIon compound shown in FIG. 4(b). The compounds are shown with their respective metal ions bound to the active site.

FIG. 5 shows SEM images of the templated PEGDA polymer showing an interconnected pore network (a-e) on the outer surface that extends to the (f-i) inside of the material.

FIG. 6 shows an illustration of the function of the time-gated (boxcar) integrator circuit.

FIG. 7 shows a schematic of the time-gated (boxcar) integrator circuit.

FIG. 8 shows a schematic for using SN7221 one-shot generator IC for generating digital trigger signals.

FIG. 9 shows a schematic for using 74XX14 NOT logic gates for delaying the gate and excitation source trigger signals.

FIG. 10 shows a schematic for using 74HC4066 bilateral switch to gate the photodetector signal.

FIG. 11 shows a schematic for “Integrator” circuit containing operational amplifier based integrator and buffer circuits.

FIG. 12 shows a schematic for peak detector circuit.

FIG. 13 shows a schematic for LF398 Sample-and-Hold IC.

FIG. 14 shows fluorescence curves of the (a) non-templated and (b) templated sensor junctions according to Example 1 showing a tenfold improvement of the response time.

FIG. 15 shows the pH response from a cross-fiber sensor junction according to Example 1 using integrated emission-excitation ratios.

FIG. 16 shows reconvolution results using a biexponential decay function. Sample decay curves and weighted residuals are shown for TCSPC data at pH 6.13 in FIG. 16(a) and for stroboscopic data at pH 7.80 in FIG. 16(b), and the resulting fractional amplitudes versus pH using the TCSPC data are shown in FIG. 16(c) and using the stroboscopic data are shown in FIG. 16(d). IRF stands for instrument response function.

FIG. 17 shows reconvolution results using a two-term nonexponential decay function. Sample decay curves and weighted residuals are shown for TCSPC data at pH 5.05 in FIG. 17(a) and for stroboscopic data at pH 6.47 in FIG. 17(b), and the resulting fractional amplitudes versus pH using the TCSPC data are shown in FIG. 17(c) and using the stroboscopic data are shown in FIG. 17(d).

FIG. 18 shows a comparative study of the % Error of a conventional detector versus a detector containing a reference junction as prepared in Example 3.

FIG. 19 shows the optical time of flight sensor array of Example 4.

FIG. 20 shows a CAD drawing of the crossed-fiber dip probe mounting fixture of Example 5.

FIG. 21 shows recorded spectra taken according to Example 5. FIG. 21(a) is a sample waveform without analyte. FIG. 21(b) shows the reference and sensor intensities before and after exposure to 1 ppm Zn(II).

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

It should be noted that a plurality of hardware and software based devices, as well as a plurality of different structural components may be utilized to implement the invention. Furthermore, and as described in subsequent paragraphs, the specific configurations illustrated in the drawings are intended to exemplify embodiments of the invention and that other alternative configurations are possible.

The terminology used herein is for the purpose of describing particular embodiments only and is not intended to be limiting. As used in the specification and the appended claims, the singular forms “a,” “and” and “the” include plural references unless the context clearly dictates otherwise.

For the recitation of numeric ranges herein, each intervening number there between with the same degree of precision is explicitly contemplated. For example, for the range 6-9, the numbers 7 and 8 are contemplated in addition to 6 and 9, and for the range 6.0-7.0, the numbers 6.0, 6.1, 6.2, 6.3, 6.4, 6.5, 6.6, 6.7, 6.8, 6.9 and 7.0 are explicitly contemplated.

As used herein, the term “about” is used synonymously with the term “approximately.” Illustratively, the use of the term “about” indicates that values slightly outside the cited values, namely, plus or minus 10%. Such values are thus encompassed by the scope of the claims reciting the terms “about” and “approximately.”

This disclosure provides apparatuses for detecting one or more analytes in a liquid sample.

“Handheld,” as used herein, refers to an item capable of fitting in a volume of 1 m×1 m×1 m and having mass of less than 100 kg.

“Initial excitation time,” as used herein, refers to the point in time when the front of an electromagnetic radiation pulse, as measured by the half-maximum of the intensity profile, interacts with the probe compound located nearest the excitation terminus of a given probe junction.

“Optical coupling,” as used herein, refers to any means of propagating electromagnetic radiation between two points. For example, a fiber optic provides optical coupling between a first end and a second end.

“Optical time of flight,” as used herein, refers to the amount of time it takes electromagnetic radiation to propagate a particular distance in a particular medium.

“Compound recovery time,” as used herein, refers to the amount of time between the initial excitation time of a first signal and the time wherein a second signal is capable of being produced. In the case of a luminescent lifetime signal, the probe compound recovery time is the same as the probe compound signal time.

“Compound signal time,” as used herein, refers to the amount of time between the initial excitation time of a first signal and the time wherein the probe compound is no longer producing the first signal. In the case of a luminescent probe compound, the probe compound signal time is the same as the compound recovery time.

“Compound detection time,” as used herein, refers to the amount of time it takes a compound to produce a measurable signal. This is the minimum total amount of time it takes to complete a measurement from the time a user begins the measurement.

“Optical signal,” as used herein, refers to an electromagnetic emission from a compound in response to an electromagnetic excitation which conveys information about the behavior or attributes of the compound. For example, an optical signal can be the resulting emission from a fluorescent chromophore that is excited by evanescent electromagnetic excitation.

### I. Apparatus

The present disclosure provides apparatuses for detecting the presence or concentration of an analyte in a liquid sample suspected of containing the analyte.

In some embodiments, the apparatus may comprise a sensor element and a control unit. In some embodiments, the apparatus may comprise an optical time of flight sensor array, a light source, a detector, and a signal processing device.

In preferred embodiments, the apparatus may function without requiring manual sampling of the liquid. In preferred embodiments, the apparatus may be handheld.

The apparatus may allow remote monitoring, a 30 second acquisition and processing time, and a sensor element field life cycle of 3-4 weeks. The apparatus may show specificity for zinc above other divalent cations.

In preferred embodiments, the apparatus may measure the concentration of the analyte in the liquid. In preferred embodiments, the apparatus may measure the presence of the analyte in the liquid above a certain threshold limit.

In some embodiments, the apparatus includes a portable, stand-alone measurement unit, a unit that can be permanently integrated into water streams and systems (where the separation between probe and signal-processing electronics is larger), and a unit with wireless communications functionality so that portable electronic devices may be used as displays.

Analyte

In some embodiments, the analyte is selected from the group consisting of metal ions, non-metal ions, electrically neutral species, chemical compounds, proteins, sugars, lipids, amines, aromatic compounds, opiates, alcohols, polynucleotides, biological and chemical warfare agents. In some embodiments, the analyte is selected from the group consisting of alkali metals, alkaline earth metals, transition metals, semi-metals, lanthanides, and actinides. In preferred embodiments, the analyte is selected from the group consisting of zinc, mercury, cadmium, chromium, copper, silver, aluminum, cobalt, iron, magnesium, manganese, nickel, lead, gold, arsenic, tin, barium, sulfur, strontium, nitrate, perchlorate, phosphates, sulfates, halides. In preferred embodiments, the analyte is selected from the group consisting of zinc ions, mercury ions, cadmium ions, chromium ions, copper ions, nickel ions, leads ions, iron ions. In preferred embodiments, the analyte is selected from the group consisting of Zn²⁺, Hg²⁺, Cd²⁺, and Cr³⁺, Cu²⁺, Fe³⁺, Fe²⁺, Pb²⁺, Ni²⁺ and combinations thereof. In one particularly preferred embodiment, the analyte is Zn²⁺.

In principle, this invention is suitable for use with any analyte that has at least one probe compound capable of producing an optical signal that changes in some way in the presence of the analyte.

Liquid

In some embodiments, the liquid is any liquid capable of containing an analyte of interest. In some embodiments, the liquid is water or organic solvent. In some embodiments, the liquid is selected from the group consisting of water, acetone, methanol, ethanol, propanol, benzene, toluene, chloromethanes, dimethylsulfoxide, ethers, ketones, glycols. In one particularly preferred embodiment, the liquid is water.

In some embodiments, the liquid is selected from the group consisting of industrial wastewater, industrial heating or cooling liquids, treatment water, municipal water. In some embodiments, the liquid is selected from the group consisting of ocean water, lake water, pond water, river water, recreational water, rainwater, highway runoff, snow melt, ground water.

### A. Sensor Element

In some embodiments, the sensor element may comprise an optical time of flight sensor array, a stem, and a control interface.

In some embodiments, the sensor element may be a dip-probe. In some embodiments, the sensor element may be left submerged in the liquid for active monitoring of analyte presence or concentration.

In some embodiments, the sensor element may have a field life cycle of greater than about 1 week, about 2 weeks, about 3 weeks, about 4 weeks, about 1 month, about 2 months, about 3 months, or about 6 months. In some embodiments, the sensor element may have a field life cycle of less than about 1 year, about 9 months, about 6 months, about 3 months, about 2 months, about 1 month, about 4 weeks, about 3 weeks, or about 2 weeks.

In preferred embodiments, the sensor element may be handheld.

### 1. Optical Time of Flight Sensor Array

In some embodiments, the optical time of flight sensor array may comprise a first waveguide comprising an excitation terminus located at the first end of the waveguide, a second waveguide comprising a signal terminus located at a first end of the second waveguide, and at least one junction.

Any waveguide capable of propagating pulsed electromagnetic radiation is suitable for use in this invention. In preferred embodiments, the waveguides are optical fibers.

In some embodiments, the optical time of flight sensor array may comprise at least one, two, three, four, five, ten, twenty, fifty, one hundred, five hundred, one thousand, ten thousand, fifty thousand, one hundred thousand, five hundred thousand, or one million junctions. In some embodiments, the optical time of flight sensor array may comprise less than one million, five hundred thousand, one hundred thousand, fifty thousand, ten thousand, five thousand, one thousand, five hundred, one hundred, fifty, forty, thirty, twenty-five, twenty, fifteen, ten or five junctions.

In some embodiments, a junction prevents optical coupling between the first waveguide and second waveguide. In some embodiments, a junction provides optical coupling between the first waveguide and species contained within the junction. In some embodiments, a junction provides optical coupling between species contained within the junction and the second waveguide. In preferred embodiments, a junction prevents optical coupling between the first waveguide and second waveguide while allowing evanescent excitation of species within the junction from electromagnetic radiation propagating within the first waveguide and allowing radiation emitted by species within the junction to enter the second waveguide.

It should be appreciated that the junctions of the optical time of flight array may be arranged in any order and separated by any distance along the first and second waveguides, so long as the optical time of flight signals remain spatially resolved. However, several embodiments have inherent advantages.

In one preferred embodiment, a first junction is located proximate to the excitation terminus relative to any other junctions on the first waveguide and proximate the signal terminus relative to any other junctions on the second waveguide, and a last junction is located distal to the excitation terminus relative to any other junctions on the first waveguide and distal the signal terminus relative to any other junctions on the second waveguide. In this embodiment, generally, the nth junction is located distal the excitation terminus relative to n other junctions on the first waveguide and distal the signal terminus relative to n other junctions on the second waveguide. The primary advantage to this arrangement is that the signals are delayed in time relative to each other, so the temporal resolution is achieved. A signal from the first junction, propagating along the second waveguide in the direction of the signal terminus, will arrive at the signal terminus before a signal from the second junction, by an amount of time equal to the optical time of flight along the first waveguide between the first and second junctions plus the optical time of flight along the second waveguide between the second and first junctions. In this embodiment, the optical time of flight from the first junction to the last junction along the first waveguide plus an optical time of flight from the last junction to the first junction along the second waveguide may be less than or equal to about 1 s, about 500 ms, about 100 ms, about 50 ms, about 10 ms, about 5 ms, about 1 ms, about 500 μs, about 100 μs, about 50 μs, about 10 μs, about 5 μs, about 1 μs, about 500 ns, about 100 ns, about 50 ns, or about 10 ns. In this embodiment, the optical time of flight from the first junction to the last junction along the first waveguide plus an optical time of flight from the last junction to the first junction along the second waveguide may be greater than bout 1 ns, about 10 ns, about 50 ns, about 100 ns, about 500 ns, about 1 μs, about 5 μs, about 10 μs, about 50 μs, about 100 μs, about 500 μs, about 1 ms, about 5 ms, about 10 ms, about 50 ms, about 100 ms, or about 500 ms. In this embodiment, the optical time of flight between any two adjacent junctions along the first waveguide plus the optical time of flight between said junctions along the second waveguide is greater than about 500 fs, about 1 ps, about 5 ps, about 10 ps, about 50 ps, about 100 ps, about 500 ps, about 1 ns, about 5 ns, about 10 ns, about 50 ns, about 100 ns, about 500 ns, about 1 μs, about 5 μs, about 10 μs, about 50 μs, about 100 μs, or about 500 μs.

In another preferred embodiment, a first junction is located proximate the excitation terminus relative to any other junctions on the first waveguide and distal the signal terminus relative to any other junctions on the second waveguide, and a last junction is located distal the excitation terminus relative to any other junctions on the first waveguide and proximate the signal terminus relative to any other junctions on the second waveguide. In this embodiment, generally, the nth junction is located distal the excitation terminus relative to n other junctions on the first waveguide and proximate the signal terminus relative to n other junctions on the second waveguide. The primary advantage to this arrangement, is that the signals will have higher signal to noise ratios for a higher number of junctions and will decrease overall detection time. A signal from the first junction, propagating along the second waveguide in the direction of the signal terminus, can arrive at the signal terminus either before or after a signal from the second junction, depending on the optical time of flight along the first waveguide between the first and second junctions and the optical time of flight along the second waveguide between the first and second junctions. The relative distance between junctions on the first and second waveguide will determine the arrival time of the signal from the first and second junctions. If the first and second junctions are located farther apart along the second waveguide than along the first waveguide, then the signal from the first junction will arrive at the signal terminus before the signal from the second junction. Similarly, if the first and second junctions are located farther apart along the first waveguide than along the second waveguide, then the signal from the second junction will arrive at the signal terminus before the signal from the first junction. Accordingly, the distance between junctions can be precisely engineered such that the signals arrive as close in time to one another as possible. In this embodiment, the longer of an optical time of flight from the first junction to the last junction along the first waveguide and an optical time of flight from the first junction to the last junction along the second waveguide is greater than about 1 ps, about 5 ps, about 10 ps, about 50 ps, about 100 ps, about 500 ps, about 1 ns, about 5 ns, about 10 ns, about 50 ns, about 100 ns, about 500 ns, about 1 μs, about 5 μs, about 10 μs, about 50 μs, about 100 μs, or about 500 μs, about 1 ms, about 5 ms, about 10 ms, about 50 ms, about 100 ms, about 500 ms. In this embodiment, the longer of an optical time of flight between two adjacent junctions along the first waveguide and an optical time of flight between said junctions along the second waveguide is greater than about 100 fs, about 500 fs, about 1 ps, about 5 ps, about 10 ps, about 50 ps, about 100 ps, about 500 ps, about 1 ns, about 5 ns, about 10 ns, about 50 ns, about 100 ns, about 500 ns, about 1 μs, about 5 μs, about 10 μs, about 50 μs, about 100 μs, or about 500 μs.

In some embodiments, the optical time of flight sensor array comprises two waveguides. In some embodiments, the optical time of flight sensor array comprises greater than two, greater than three, greater than four, greater than five, greater than ten, greater than twenty, greater than one hundred, or greater than one thousand waveguides. In some embodiments, the optical time of flight sensor array comprises a single waveguide for excitation radiation and a plurality of waveguides for signal radiation. In some embodiments, the optical time of flight sensor array comprises a plurality of waveguides for excitation radiation and a single waveguide for signal radiation. In some embodiments, the optical time of flight sensor array comprises a plurality of waveguides for excitation radiation and a plurality of waveguides for signal radiation.

In some embodiments, the junctions of the optical time of flight sensor array are adapted to fit within a housing having a maximum spatial dimensions of about 50 cm×50 cm×50 cm, wherein the junctions can be immersed in a standing body of the liquid, the liquid can come into contact with each junction, and the analyte can diffuse to and from each junction. In some embodiments, all of the junctions of the optical time of flight sensor array are capable of being immersed in the liquid. In preferred embodiments, all of the probe junctions of the optical time of flight sensor array are capable of being immersed in the liquid. In some embodiments, all of the probe junctions are capable of being immersed in the liquid while at the same time all of the reference junctions are not immersed in the liquid. In some embodiments, all of the probe junctions and reference junctions are capable of being immersed in the liquid.

i. Probe Junction

In some embodiments, a probe junction may comprise a probe compound and a probe polymer.

In particularly preferred embodiments, a probe junction may be prepared by preparing a precursor solution containing polyethylene glycol diacrylate (PEGDA, number-average molecular weight 575), tripropyl triacrylate (TPT), 2,2-dimethyoxy-2-phenylacetophenone (DMPA), templating polystyrene or poly(methyl methacrylate) microspheres, and a probe compound. A first optical fiber has a portion of its cladding removed at a desired location. A second optical fiber has a portion of its cladding removed at a desired location. The first and second optical fiber are cleaned with acetone and then nitric acid. The first and second optical fibers are mounted in a preferably at but not limited to orthogonal orientation relative to one another. A drop of the precursor solution is placed on the intersection of the first and second optical fibers and cured for thirty seconds with 365 nm UV light. The probe junction is then submerged in an appropriate dissolving agent (e.g. toluene or acetone) for 24 or more hours to remove the microspheres and allowed to air dry for one hour.

Probe Compound

In general, a probe compound is any entity capable of producing a signal that varies in some fashion in the presence of an analyte relative to the absence of the analyte. In preferred embodiments, a probe compound is a luminescent compound that emits an optical signal upon evanescent excitation, wherein the optical signal varies with respect to the concentration of the analyte. In preferred embodiments, the optical signal varies in a linear fashion with respect to the concentration of the analyte. In preferred embodiments, the probe compound is selective to produce an optical signal in the presence of the analyte, but not in the presence of compounds with properties similar to the analyte.

In some embodiments, the probe compound is selected from the group consisting of luminescent chromophores, quantum dots and other luminescent nano- and micro-structures, whose luminescence change in response to the analyte. In some embodiments, the probe compound is fluorescein acryl amide. In preferred embodiments, the probe compound is a Fluozin™-1 compound. In some embodiments, the probe compound is a MercurIon-1, a CadmIon-1, or a modified BODIPY dye with a metal ion receptor cite.

In preferred embodiments, the probe compound is a luminescent compound that produces a first optical signal in the absence of an analyte and a second optical signal in the presence of the analyte, wherein said first optical signal and second optical signal have different peak signal intensity, different integrated signal intensity, different signal decay rate, different signal wavelength, or a combination thereof.

In preferred embodiments, the probe compound further produces a third optical signal in the presence of a first concentration of the analyte and a fourth optical signal in the presence of a second concentration of the analyte. In preferred embodiments, the probe compound further produces a fifth optical signal in the presence of a third concentration of the analyte, wherein the third, fourth and fifth optical signal are linear when plotted with respect to concentration.

In some embodiments, the probe compound may comprise a probe compound signal time of greater than about 1 ps, about 5 ps, about 10 ps, about 100 ps, about 1 ns, about 5 ns, about 10 ns, about 100 ns, 1 μs, about 5 μs, about 10 μs, about 100 μs, or about 1 ms. In some embodiments, the probe compound may comprise a probe compound signal time of less than about 1 ms, about 500 μs, about 100 μs, about 10 μs, about 1 μs, about 500 ns, about 100 ns, about 10 ns, about 1 ns, about 500 ps, about 100 ps, or about 10 ps.

In some embodiments, the probe compound may comprise a probe compound recovery time of greater than about 1 ps, about 5 ps, about 10 ps, about 100 ps, about 1 ns, about 5 ns, about 10 ns, about 100 ns, 1 μs, about 5 μs, about 10 μs, about 100 μs, about 1 ms, about 5 ms, about 10 ms, about 100 ms, or about 1 s. In some embodiments, the probe compound may comprise a probe compound recovery time of less than about 1 s, about 500 ms, about 100 ms, about 10 ms, about 1 ms, about 500 μs, about 100 μs, about 10 μs, about 1 μs, about 500 ns, about 100 ns, about 10 ns, about 1 ns, about 500 ps, about 100 ps, or about 10 ps.

In some embodiments, the probe compound may comprise a probe compound detection time of greater than about 1 ms, about 5 ms, about 10 ms, about 100 ms, about 1 s, about 5 s, about 10 s, about 20 s, about 30 s, about 1 minute, about 5 minutes, about 10 minutes, about 15 minutes, or about 20 minutes. In some embodiments, the probe compound may comprise a probe compound detection time of less than about 20 minutes, about 15 minutes, about 10 minutes, about 5 minutes, about 1 minute, about 30 s, about 20 s, about 10 s, about 5 s, about 1 s, about 500 ms, about 100 ms, about 10 ms, or about 1 ms.

A family of BODIPY-based fluorosensors with high selectivity and sensitivity towards different metal ions was designed from fluorosensors described in the literature. Another modification is to add a vinyl substituent that allows for covalent attachment of the sensor to the polymer in order to minimize leaching of the sensor from the highly porous polymer matrix and increase sensor longevity.

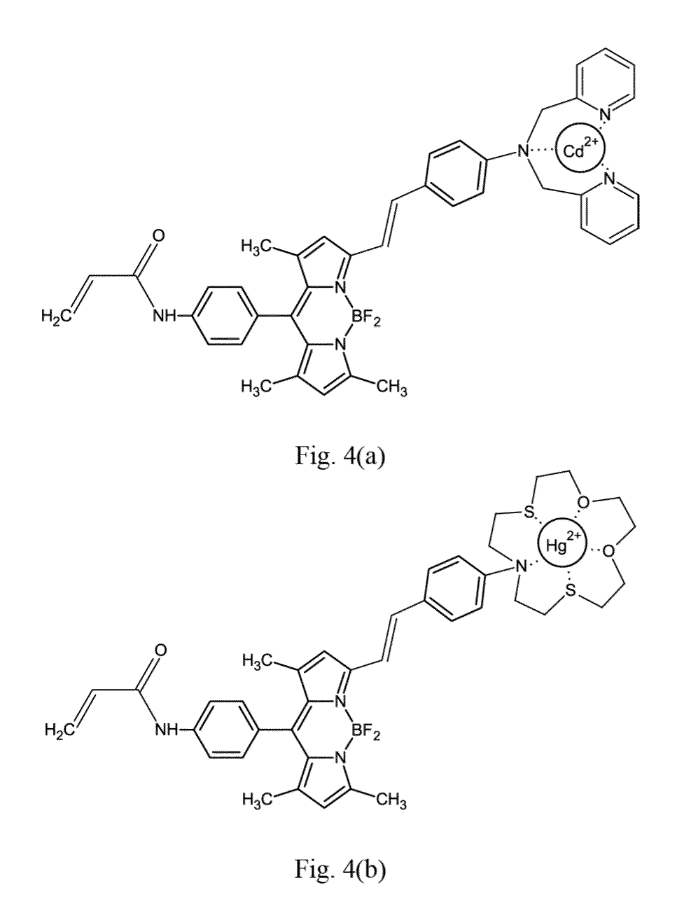

Many fluorosensors have a response to more than one analyte (i.e. interferent), yielding inaccuracies with complex samples. However, the literature has cited two sensors that yield a wavelength-selective response to Hg(II) and Cd(II) [Peng et al., 2007; Ábalos et al., 2009]. Based on this literature, a family of fluorosensors can be designed with high selectivity towards target metal ions. CadmIon-1, shown in FIG. 4(a), is one example. It consists of three functional units.

MercurIon-1, shown in FIG. 4(b) is composed of three components: a BODIPY-based fluorophore, a highly-selective binding-site for Hg(II), and linking group that allows for covalent attachment of the fluorosensor to polymer constituting the fiber cladding during photopolymerization. MercurIon-1 can be synthesized from commercially available reagents using methods described in the literature. The spectral properties of a wide range of BODIPY dyes have been described in the literature. The BODIPY unit was chosen because of excitation wavelengths around 500 nm (where optical fibers have high transmission), high fluorescence quantum yield, and large Stokes shift that allows for spectral separation of excitation and emission wavelengths, and pH-independent emission over a pH range of three to ten. The NS₂O₂ metal receptor unit was chosen for high selectivity for Hg(II) in aqueous solutions and for sensor reversibility. When covalently attached to a BODIPY fluorophore, binding of Hg(II) to the receptor will dramatically increase the fluorescence quantum yield of the BODIPY subunit. It was suggested that this fluorescence enhancement upon Hg(II) binding is due to suppression of intramolecular charge transfer to the fluorophore as the metal cation reduces the electron-donating ability of the nitrogen atom in the crown structure. Although several metal cations can bind to the NS₂O₂ macrocycle, like Cu(II), we expect MercurIon-1 to undergo a distinct shift of the emission wavelength to 578 nm upon Hg(II) binding; binding of other metals cations is expected to cause a different emission wavelength shift to the spectral region around 670 nm. Also, the NS₂O₂ unit has little response to common anions in the presence of Hg(II).

The acrylamide group allows for covalent attachment during photopolymerization to greatly minimize leaching of the sensor from the porous polymer and subsequent performance degradation. CadmIon-1 contains a boron-dipyrromethene (BODIPY) based fluorophore and a metal ion binding site. BODIPY dyes have the advantages of visible light excitation (green region) with a high molar absorption coefficient, relatively high quantum yield, and high photostability. When no metal is bound to the receptor site, the BODIPY unit undergoes an internal charge transfer (ICT) mechanism due to the electron donating ability of the receptor site. However, upon binding, the ICT process(es) are suppressed resulting in a spectral shift in emission and a change in quantum yield (i.e. fluorescent intensity). Moreover, upon binding to Cd(II) in the presence of other metal cations, a wavelength-selective response is expected for Cd(II), even in the presence of the interferent Zn(II).

Numerous receptor sites with selectivity towards different metal cations reported in the literature, which include aza-crown and thia-aza-crown ethers [Zeng et al., 2005; He et al., 2006; Dodani et al., 2009]. Although multiple metals can bind to a particular structure, a wavelength-selective response may be obtained when coupled to the BODIPY fluorosensor in a manner similar to CadmIon-1. A family of sensors with selectivity towards a target analyte may be incorporated into our fiber array architecture for detecting multiple analytes in complex samples.

Probe Polymer

In general, the optical properties of the probe polymer must be such that a probe junction containing the probe polymer can undergo evanescent excitation by electromagnetic radiation propagating along the first waveguide. In general, the optical properties of the probe polymer must be such that a signal from a probe junction containing the probe polymer can be coupled into the second waveguide evanescently or directly.

In some embodiments, the probe polymer is a porous polymer. In principle, the probe polymer may have any porosity sufficient to allow the liquid to freely flow and the analyte to freely diffuse to the interior of the probe junction. In some embodiments, the probe polymer has greater than 1%, greater than 2%, greater than 3%, greater than 4%, greater than 5%, greater than 6%, greater than 7%, greater than 8%, greater than 9%, greater than 10%, greater than 15%, greater than 20%, greater than 25%, greater than 30%, greater than 35%, greater than 40%, greater than 45%, greater than 50%, greater than 55%, greater than 60% porosity.

In preferred embodiments, the probe polymer comprises a poly(ethylene)glycol diacrylate polymer.

ii. Reference Junction

In order to combat fluctuation in excitation radiation intensity, it is advantageous to include a reference junction, which can provide an optical signal that corresponds to excitation intensity at said junction. Doing so, and placing said reference junction in close proximity to a probe junction, can provide a means of accurately determining the excitation radiation intensity at said probe junction. The result of a more accurate determination of excitation radiation intensity is a more accurate spectroscopic measurement, and in turn, a more accurate measurement of the presence or concentration of an analyte.

In some embodiments, reference junctions are not immersed in the liquid when probe junctions are immersed in the liquid.

### Reference Compound

In principle, a reference compound is any entity capable of producing an optical signal which varies with respect to the intensity of the excitation radiation, but does not vary with respect to the concentration of the analyte. In preferred embodiments, the optical signal does not vary with respect to other variables such as temperature, pressure, pH, dissolved oxygen, or a combination thereof. In some embodiments, the optical signal varies less than 50%, less than 40%, less than 25%, less than 20%, less than 15%, less than 10%, less than 5%, less than 4%, less than 3%, less than 2%, less than 1%, less than 0.5%, or less than 0.1% with respect to said other variables. In some embodiments, the optical signal does vary with respect to one or more of the above other variables, but not with respect to the concentration of the analyte.

In some embodiments, the reference compound may be selected from the group consisting of luminescent chromophores, microspheres containing luminescent chromophores, nanoparticles, and combinations thereof. In some embodiments, the reference compound is selected from the group consisting of photostable luminescent chromophores, including but not limited rhodamine B, rhodamine-6G, quinine sulfate, microspheres containing luminescent chromophores, difluorofluorescein, dichlorofluorescein. Other potential candidates include quantum dots and other luminescent nano- and micro-structures whose luminescence does not change in response to the analyte.

In preferred embodiments, the reference compound is rhodamine-110.

### Reference Polymer

In preferred embodiments, the reference polymer encompasses the reference compound and prevents external species from coming into contact with the reference compound. In principle, any reference polymer can be used that maintains the physical integrity of the reference junction and which possesses the optical properties required for a junction as described herein.

In some embodiments, the reference polymer is a sufficiently nonporous polymer.

In preferred embodiments, the reference polymer is selected from the group consisting of polystyrene, polyacrylonitrile, PEGDA, or a combination thereof.

### 2. Stem

In some embodiments, the stem is adapted to provide independent orientation for the optical time of flight sensor array relative to the control interface. In some embodiments, the stem is adapted to provide optical coupling between the excitation control interface and the excitation terminus and between the signal control interface and the signal terminus. In some embodiments, the stem is adapted to provide optical coupling between the light source and the excitation terminus and between the detector and the signal terminus. In some embodiments, the stem is adapted to provide optical coupling between the optical time of flight sensor array and both the light source and the detector.

In preferred embodiments, the stem comprises one waveguide to provide optical coupling between the excitation control interface and the excitation terminus and one waveguide to provide optical coupling between the signal terminus and the signal control interface. In preferred embodiments, the stem comprises one waveguide to provide optical coupling between the light source and the optical time of flight sensor array and one waveguide to provide optical coupling between the optical time of flight sensor array and the detector.

In some embodiments, the stem may be adapted to conduct radiation with a loss of intensity of less than about 50%, less than about 75%, less than about 90%, less than about 95%, less than about 99% or less than about 99.9%. In some embodiments, the stem is adapted to conduct radiation with a pulse broadening of less than about 1000%, about 500%, about 400%, about 300%, about 200%, or about 100% as measured by full-width at half-maximum intensity profile.

In some embodiments, the stem may be greater than about 1 μm, about 5 μm, about 10 μm, about 50 μm, about 100 μm, about 500 μm, about 1 mm, about 5 mm, about 10 mm, about 50 mm, about 100 mm, about 500 mm, about 1 m, about 5 m, about 10 m, about 50 m, about 100 m, about 500 m, about 1 km, about 5 km, about 10 km, about 50 km, or about 100 km in length. In some embodiments, the stem may be less than about 100 km, about 50 km, about 10 km, about 5 km, about 1 km, about 500 m, about 100 m, about 50 m, about 10 m, about 5 m, about 1 m, about 500 mm, about 100 mm, about 50 mm, about 10 mm, about 5 mm, about 1 mm, about 500 μm, about 100 μm, about 50 μm, about 10 μm, or about 5 μm in length.

### 3. Control Interface

The control interface reproducibly orients the sensor element, such that electromagnetic radiation is reproducibly directed into and out of the optical time of flight sensor array. The control interface aligns with the sensor interface to provide optical coupling between the optical time of flight sensor array and both the light source and detector.

In some embodiments, the control interface optionally includes a means of reducing or eliminating reflections.

### B. Control Unit

In some embodiments, the control unit comprises a light source, a detector, a signal processing device, and a sensor interface.

### 1. Light Source

Light sources suitable for use in optical time of flight spectroscopy can be used in the present invention.

In preferred embodiments, the light source is a pulsed light-emitting diode, a pulsed laser, a pulsed lamp, a pulsed laser diode, or a pulsed microchip laser. Suitable commercially available pulsed light sources include a subnanosecond, passively Q-switched 532 nm microchip laser, FP2-532-5-0.5-CRC available from Concepts Research Corporation, Belgium, Wis.; a Bright Solutions Wedge HF-355 or HF-532 compact air-cooled short pulse, Q-switched laser available from RPMC Lasers, Inc, O'Fallon, Mo.; and a LD-445-1000MG 445 nm, 1000 mW laser diode (LD), a LD-473-20PD 473 nm, 20 mW LD, a LD-488-20PD 488 nm, 20 mW LD, a ELJ-465-627 465 nm, high power LED, or a ELJ-505-627 505 nm, high power LED available from Roithner Lasertechnik, Vienna, Austria.

Pulsed Electromagnetic Radiation

In principle, any pulsed electromagnetic radiation capable of producing an optical signal from a probe compound may be used in the present invention. In preferred embodiments, the pulsed electromagnetic radiation is capable of producing an optical signal from all probe compounds via evanescent excitation.

In some embodiments, the pulsed electromagnetic radiation may have an average wavelength of greater than about 300 nm, about 400 nm, about 500 nm, about 600 nm, about 700 nm, about 800 nm, about 900 nm, about 1000 nm, about 1500 nm, or about 2000 nm. In some embodiments, the pulsed electromagnetic radiation may have an average wavelength of less than about 2000 nm, about 1500 nm, about 1000 nm, about 900 nm, about 800 nm, about 700 nm, about 600 nm, about 500 nm, about 400 nm, about 300 nm.

In some embodiments, the pulsed electromagnetic radiation may have an average full duration at half maximum pulse duration of greater than about 1 fs, about 10 fs, about 50 fs, about 100 fs, about 500 fs, about 1 ps, about 5 ps, about 10 ps, about 50 ps, about 100 ps, about 500 ps, about 1 ns, about 5 ns, about 10 ns, about 50 ns, about 100 ns. In some embodiments, the pulsed electromagnetic radiation may have an average full duration at half maximum pulse duration of less than about 500 ns, about 100 ns, about 50 ns, about 10 ns, about 5 ns, about 1 ns, about 500 ps, about 100 ps, about 50 ps, about 10 ps, about 1 ps, about 500 fs, about 100 fs, about 50 fs, about 10 fs, or about 1 fs.

In some embodiments, the pulsed electromagnetic radiation may have a repetition rate of greater than about 500 mHz, about 1 Hz, about 5 Hz, about 10 Hz, about 50 Hz, about 100 Hz, about 500 Hz, about 1 kHz, about 5 kHz, about 10 kHz, about 50 kHz, about 100 kHz, about 500 kHz, about 1 MHz, about 5 MHz, about 10 MHz, about 50 MHz, about 100 MHz. In some embodiments, the pulsed electromagnetic radiation may have a repetition rate of less than about 100 MHz, about 50 MHz, about 10 MHz, about 5 MHz, about 1 MHz, about 500 kHz, about 100 kHz, about 50 kHz, about 10 kHz, about 5 kHz, about 1 kHz, about 500 Hz, about 100 Hz, about 50 Hz, about 10 Hz, about 5 Hz, and about 1 Hz.

### 2. Detector

Detectors suitable for use in optical time of flight spectroscopy can be used in the present invention. Suitable commercially available detectors include Hamamatsu H10720 and H10721 PMT modules available from Hamamatsu Photonics, K.K., Hamamatsu City, Japan.

In preferred embodiments, the detector is capable of single photon detection and has a response time of less than about 50 ns.

In some embodiments, the detector is selected from the group consisting of photomultiplier tube, hybrid photomultiplier tube, charge-coupled device, avalanche photodiode, multi-channel plate, photodiode arrays, and combinations thereof. In preferred embodiments, the detector is a photomultiplier tube.

### 3. Signal Processing Device

Time-Gated Integrator Circuit

A time-gated integrator circuit was designed to integrate nanosecond timescale photomultiplier pulses and output a voltage proportional to the integrated value of the input pulse for a duration of one second or more. Within the signal processing device, the time-gated integrator circuit fulfils three objectives: (1) Replace a fast data acquisition device (e.g. oscilloscope or fast ADC) with a slow, inexpensive data acquisition device, such as a voltmeter or an analog input on a microcontroller. (2) Utilize hardware level signal processing—i.e. integration of the input pulse and storing the corresponding voltage for a duration of one second or more. (3) To gate or synchronize signal processing with the source trigger in order to reduce noise and interference from stray light incident on the photodetector.

The digital component of the time-gated circuit provides three trigger signals from a master trigger signal. Here, a microcontroller provided the master trigger signal. One-shot generators (SN74221 IC) are used to provide square wave pulses. The pulse width is programmed with an external resistor and capacitor. Additionally, a series of external resistors and/or capacitors can be connected to the one-shot generator via DIP switches to allow for PCB level programming of the triggering pulse width.

“One-Shot Generator 1” controls a bilateral switch to gate the input of the photodetector to the analog portion of the circuit. “One-Shot Generator 1” has a pulse width that can range from tens to hundreds of nanoseconds (e.g. through DIP switch programming), depending on the characteristics of the PMT photocurrent pulses (e.g. pulse width).

“One-Shot Generator 2” triggers a Sample-and-Hold IC. A pulse width on the order of 5-10 μs was used for the IC used here.

“One-Shot Generator 3” triggers the excitation source. Its pulse width depends on the desired repetition rate. For the work here, the source has a maximum repetition rate of 10 kHz, so the pulse width of 100 μs or more is appropriate.

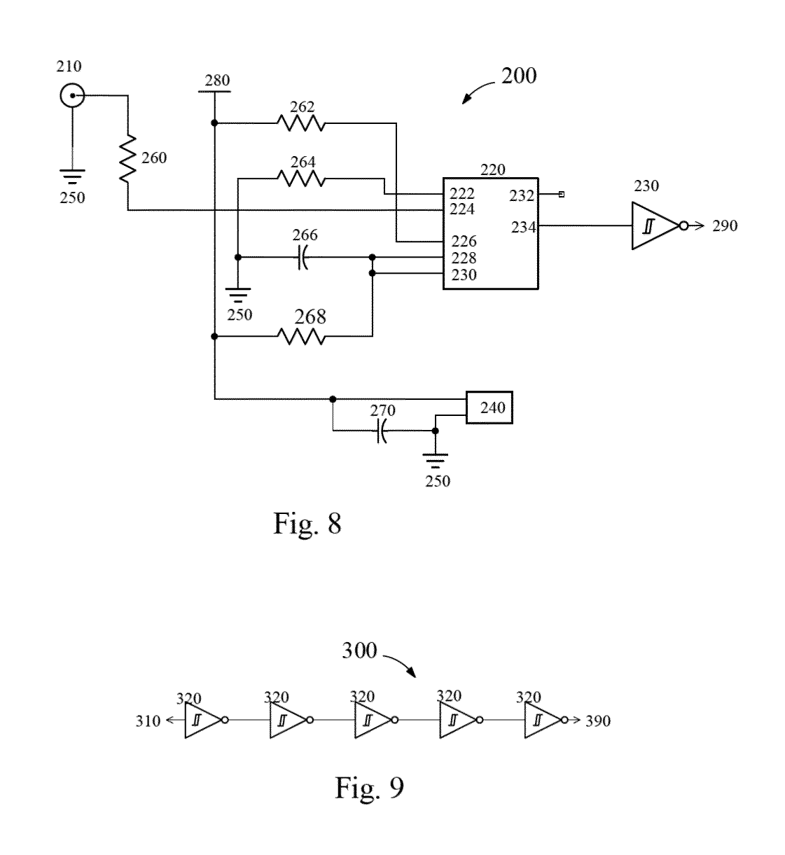

FIG. 8 shows a circuit diagram for a one-shot generator circuit 200 suitable for use as “One-Shot Generator 1”, “One-Shot Generator 2” or “One-Shot Generator 3”. The components of FIG. 8 are a trigger input 210; a one-shot generator (SN74221 IC) 220 with an A terminal 222, a B terminal 224, a CLR terminal 226, a Cₑₓₜ terminal 228, a Rₑₓₜ/Cₑₓₜ terminal 230, a positive pulse output terminal 232 and a Q̅ terminal 234; an inverter (74AC14) 230; a power supply pin 240; a ground 250; a current limiting resistor 260; a tie-up resistor (4.7 kΩ) 262; a tie-down resistor (1.0 kΩ) 264; a timing capacitor (Cₑₓₜ) 266; an external resistor (Rₑₓₜ) 268; a filtering capacitor 270; +5 V 280; and an output voltage 290.

FIG. 9 shows a circuit diagram for an optional delay circuit 300. The optional delays are used to ensure that the PMT gating switch is opened slightly before the excitation source is triggered. Here, the delay originates from the inherent propagation delay from one or more 74AC14 NOT gates 320. The optional delay circuit has an input 310 and an output 390. In an alternative arrangement, 74ACT14 or 74HC14 gates may be compatible in place of the 74AC14 gates. Also, these gates utilize a “Schmitt trigger” that sharpen the temporal response (i.e. rising and falling edges) of the respective trigger signal. Alternatively, a fixed delay line IC can be used to provide the desired delay for the excitation source (e.g. DS1100-XXX).

After one photomultiplier output pulse has been recorded, the microcontroller will provide a reset signal to the “Peak Detector” and “Sample-and-Hold” portions of the analog circuit to discharge the respective storage capacitors.

The analog portion circuit contains five major components: a gating switch, an integrator, a peak detector, a sample-and-hold (S&H) circuit, and a voltage-to-frequency converter. The photodetector response is gated with a bilateral switch. When the switch is closed by “One-shot Generator 1”, the preamplifier can amplify the input signal by a selectable gain factor of 1, 2, or 4, and the integrator outputs a voltage waveform proportional to the integral of the photodetector response. Since this signal will decay in time, the peak detector records the maximum of the integrator output (i.e. the voltage proportional to the integral) with a storage capacitor. This storage capacitor, too, will droop over the course of hundreds of microseconds, so a S&H circuit is used to store the peak detector voltage for longer periods of time (i.e. one second or more). The precision voltage-to-frequency converter outputs a square-wave with a frequency proportional to the input voltage from the sample-and-hold circuit. Alternatively, an 18-bit or higher analog-to-digital converter can used instead of the voltage-to-frequency converter. Finally, after one photomultiplier pulse has been recorded, the microcontroller will provide a reset signal to the “Peak Detector” and “Sample-and-Hold” portions of the analog circuit to discharge the respective storage capacitors. This has 2 benefits. One it is easier (on a hardware level) to count pulses than to digitize an analog voltage. Secondly, a pulse counter can potentially have a higher resolution than an analog digitizer—here, the voltage-to-frequency converter can output a frequency of 10 Hz to 100 kHz (i.e. 99990 graduations) with less than 0.03% nonlinearity, while a digitizer with a 12-bit resolution has 4096 graduations and a digitizer with 16-bit resolution has 65536 graduations.

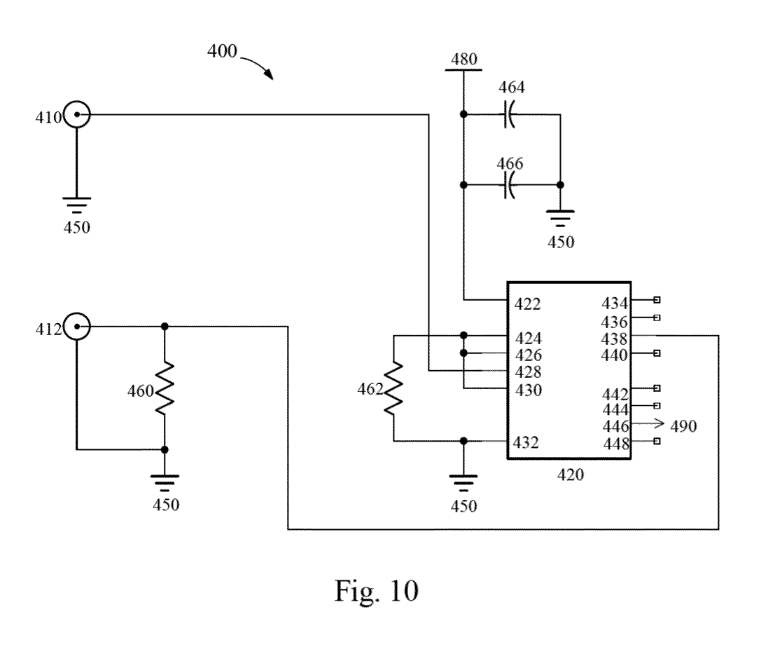

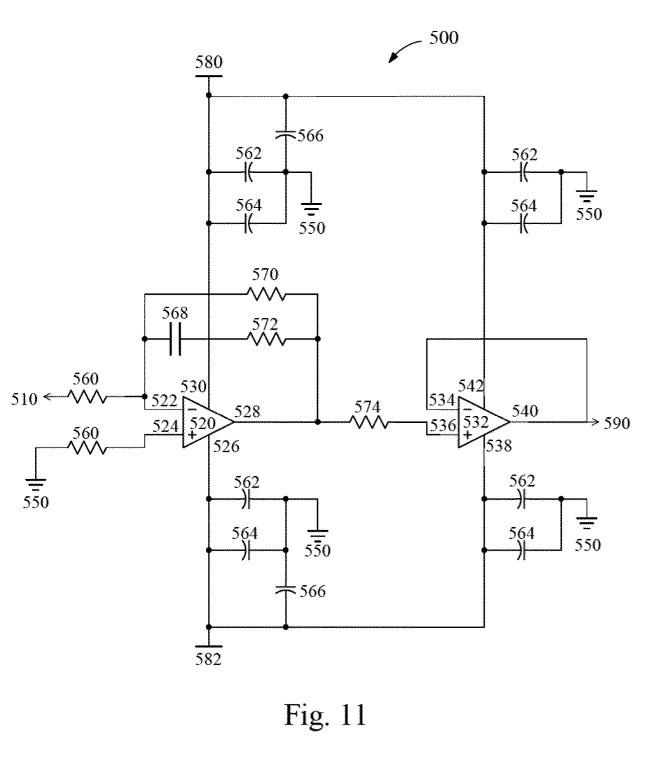

FIG. 10 shows a circuit diagram for the “Bilateral Switch” circuit 400. The components of FIG. 10 are a gate trigger input 410; a photomultiplier tube input 412; a 74HC4066N 420 with a Vcc terminal 422, a 1E terminal 424, a 2E terminal 426, a 3E terminal 428, a 4E terminal 430, a GND terminal 432, a 1Y terminal 434, a 2Y terminal 436, a 3Y terminal 438, a 4Y terminal 440, a 1Z terminal 442, a 2Z terminal 444, a 3Z terminal 446, and a 4Z terminal 448; a ground 450; a 49.9Ω resistor 460; a 1.0 kΩ resistor 462; a 4.7 μF capacitor 464; a 0.1 μF capacitor 466; a +5 V 480; and an output voltage 490. FIG. 11 shows a circuit diagram for the “Integrator” circuit 500. The components of FIG. 11 are a voltage input 510; an AD8055AN 520 with a 2 terminal 522, a 3 terminal 524, a 4 terminal 526, a 6 terminal 528 and a 7 terminal 530; a second AD8055AN 532 with a 2 terminal 534, a 3 terminal 536, a 4 terminal 538, a 6 terminal 540 and a 7 terminal 542; a ground 550; a 100Ω resistor 560; a 0.1 μF capacitor 562; a 0.01 μF capacitor 564; a 10 μF capacitor 566; a 100 pF capacitor 568; a 47 kΩ resistor 570; a 24.9Ω resistor 572; a 1 kΩ resistor 574; a +5 V 580; a −5 V 582; and an output voltage 590.

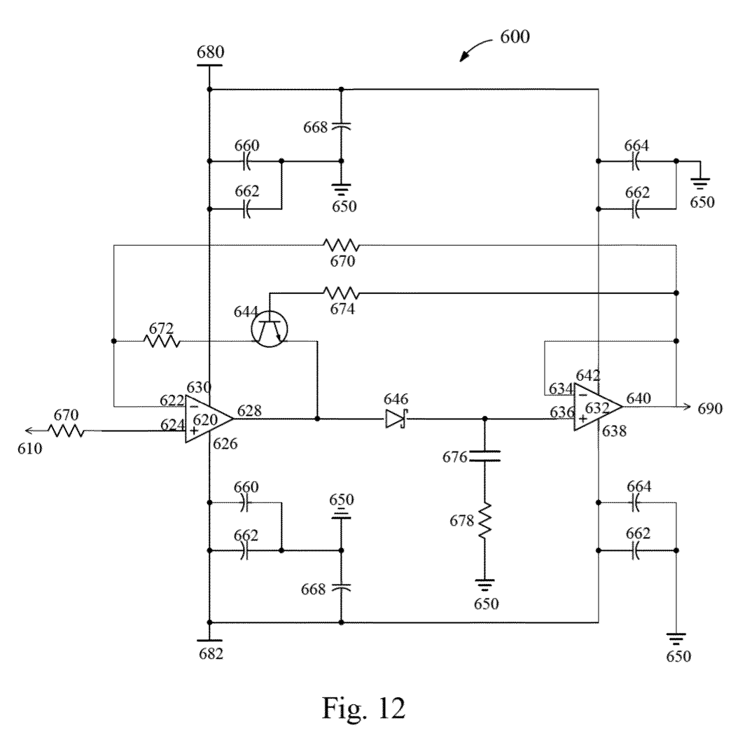

FIG. 12 shows a circuit diagram for the “Peak Detector” circuit 600. The components of FIG. 12 are a voltage input 610; an AD847JN 620 with a 2 terminal 622, a 3 terminal 624, a 4 terminal 626, a 6 terminal 628 and a 7 terminal 630; an AD843JN 632 with a 2 terminal 634, a 3 terminal 636, a 4 terminal 638, a 6 terminal 640 and a 7 terminal 642; a PN2222A 644; a BAT46 646; a ground 650; a 1.0 μF capacitor 660; a 0.01 μF capacitor 662; a 0.1 μF capacitor 664; an optional capacitor 668; a 1 kΩ resistor 670; a variable resistor (R₁=1.0 kΩ) 672; a resistor (R_{base}) 674; a 560 pF capacitor 676; a 75.0Ω resistor 678; a +5 V 580; a −5Ω 682; and an output voltage 690.

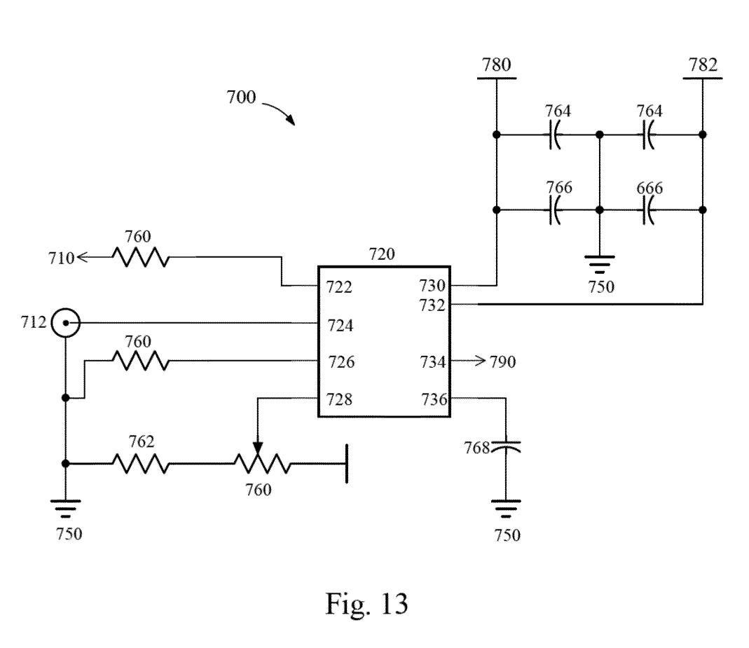

FIG. 13 shows a circuit diagram for the “Sample-and-Hold” circuit 700. The components of FIG. 12 are a voltage input 710; a trigger input 712; an LF398 720 with an IN terminal 722, a LOGIC terminal 724, a LOGIC_REF terminal 726, an OFF_ADJ terminal 728, a V⁺ terminal 730, a V⁻ terminal 732, an OUT terminal 734 and a Ch terminal 736; a ground 750; a 1.0 kΩ resistor 760; an 18 kΩ resistor 762; a 4.7 μF capacitor 764; a 0.01 μF capacitor 766; an 1800 pF capacitor 768; a +12 V 680; a −12 V 782; and a voltage output 790.

In one particular embodiment, ceramic capacitors may be used for capacitors having values of 0.01 μF or less, solid tantalum capacitors may be used for capacitors having values between 0.1 μF and 10 μF, and electrolytic capacitors may be used for capacitors having values above 10 μF. In one particular embodiment, an SN74221N in DIP package, available commercially from Texas Instruments, Dallas, Tex., may be used. In one particular embodiment, a SN74HC4066N quad bilateral switch DIP package, available commercially from Texas Instruments, Dallas, Tex., may be used. In one particular embodiment, 74AC14PC and MM74HC14N DIP package hex inverters, available commercially from Fairchild Semiconductors, San Jose, Calif., may be used. In one particular embodiment, an Arduino Duemilanove microcontroller may be used to generate a master trigger signal. In one particular embodiment, AD8055ANZ DIP package 300-MHz voltage feedback operational amplifiers, available commercially from Analog Devices, Norwood, Mass., may be used. In one particular embodiment, an AD847JNZ DIP package 50-MHz operational amplifier and AD843KNZ DIP package 34-MHz JFET operational amplifier, available commercially from Analog Devices, Norwood, Mass., may be used. In one particular embodiment, a LF398N monolithic sample-and-hold circuit, available commercially from National Semiconductor, Santa Clara, Calif.

In some embodiments, a suitable power supply may be selected from a KA7805ETU (7805, +5V) fixed linear regulator, a LM7905CT (7905, −5V) fixed linear regulator, a LM317T (317) adjustable linear regulator, or a LM337T (337) adjustable linear regulator, each available commercially from Fairchild Semiconductors, San Jose, Calif.

The photodetector is terminated with a 50-Ohm resistor and connected to “Bilateral Switch 1”. Also, the photodetector signal can be AC coupled to the analog circuit by placing a capacitor (e.g. 1 nF) between the 50-Ohm resistor and bilateral switch.

The preamplifier is composed of two fast operational amplifiers (e.g. 300 MHz, AD8011 or AD8055). Each amplifier is configured with a selectable gain of 1 or 2 to optionally amplify the photodetector response.

A fast operational amplifier (e.g. 300 MHz) integrator circuit is used to integrate the desired photodetector response. A second operational amplifier is used as buffer (i.e. unity gain amplifier) between the integrator and peak detector subcircuits. A third operational amplifier can be optionally added (omitted in the diagram) to amplify the integrator output for the peak detector. For instance, a third AD8055 can be configured in a non-inverting manner a selectable gain of 1, 2, or 5.

The “Peak Detector” records the maximum voltage from the “Integrator” component that corresponds to integral of the photodetector response. The maximum voltage is stored on the storage capacitor. This capacitor should have low leakage (e.g. polypropylene) to minimize droop and low dielectric absorption to minimize hysteresis. Also, an operational amplifier with a low input bias current (e.g. JFET) is used as a unity-gain buffer to minimize the droop of the storage capacitor.

The storage capacitor in the “Peak Detector” component will eventually droop. The observed droop on the breadboard occurred over a period of milliseconds. A Sample-and-Hold circuit can be used in conjunction with a larger storage capacitor to increase the storage time of the integrated photodetector response. This capacitor should have low leakage (e.g. polypropylene) to minimize droop and low dielectric absorption to minimize hysteresis. Here, a LF398 Sample-and-Hold IC was used to record the output of the “Peak Detector” over a 6-10 μs duration where the droop of the peak detector storage capacitor is minimal.

The voltage-to-frequency converter will output a square wave with frequency proportional to the sample-and-hold output voltage. A precision voltage-to-frequency converter with an output frequency range over 10 Hz to 100 kHz and with less than 0.03% nonlinearity can be made using a LM331 IC. The first op amp amplifies and inverts the sample-and-hold output (in the range of 0 to +5 V) to match the 0 to −10V input on the LM331 V-to-F converter. The second op amp compensates for the voltage offset of the input comparator on LM331 V-to-F converter and thus, increases accuracy for small input signals.

Alternatively, a second optional operational amplifier (e.g. TLC251, LF351) with programmable gain can be used to match to the “Sample-and-Hold” output to the voltage range of the input ADC (e.g. microcontroller).

### 4. Sensor Interface

The sensor interface provides a means of reproducibly coupling electromagnetic radiation from the control unit into the sensor element and reproducibly coupling electromagnetic radiation from the sensor element into the control unit. Preferably, the sensor interface provides a means of reproducibly coupling electromagnetic radiation from the light source into the excitation terminus and reproducibly coupling electromagnetic radiation from the signal terminus into the detector. The sensor interface aligns with the control interface to provide optical coupling between the optical time of flight sensor array and both the light source and detector.

In some embodiments, the control interface comprises a protrusion and the sensor interface comprises a recess, wherein the protrusion fits into the recess. In some embodiments, the sensor interface comprises a protrusion and the control interface comprises a recess, wherein the protrusion fits into the recess.

### II. Handheld Apparatus

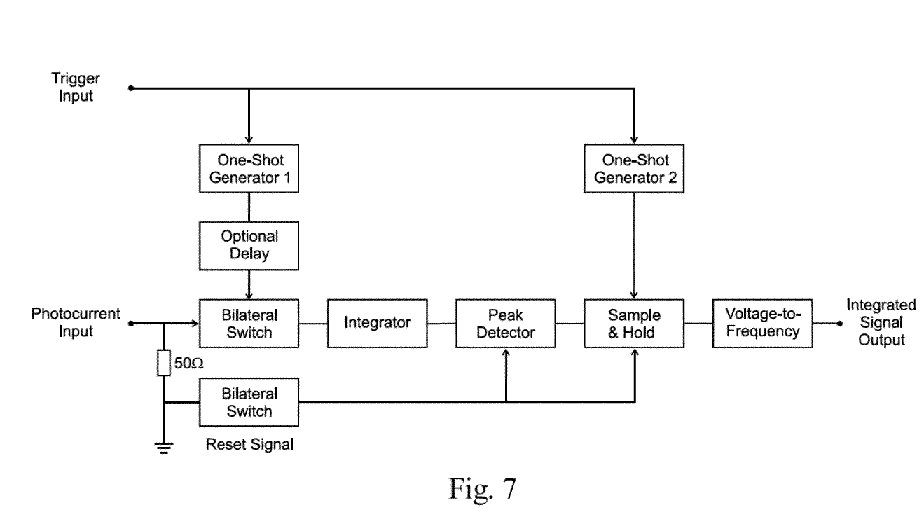

In some embodiments, a handheld apparatus according to the present invention may be prepared by assembling the trigger and detection electronics (boxcar integrator circuit) as described in FIG. 7. One of skill in the art would be capable of integrating the electronics as described in FIG. 7 into a handheld device by a variety of means. For example, one of skill in the art would be capable of designing a printed circuit board, which could be manufactured by external suppliers, and connecting the electronic components to this board. One of skill in the art could use a breadboard-like platform instead of the printed circuit to place and connect electronics components via electrical wires.

In some embodiments, a handheld apparatus according to the present invention may have a power supply. In some embodiments, the power supply may be a battery or an AC adapter. In one particular embodiment, the power supply is a Tenergy 31428 Lithium-Ion Polymer Battery, 22.5V, 5000 mAh.

In some embodiments, the microcontroller may be connected to the display screen, command keys, power switch, trigger and detection electronics, and to the power supply. Various commercially available displays are available for handheld devices (e.g. liquid crystal displays, from simple 2 line monochrome displays to larger, back lit color liquid crystal displays). Suitable commercially available displays include a Hitachi HD44780 series LCD display or a Sharp LQ043TDX02 4.3-inch TFT-LCD display with 24-bit color, 480×272 pixels. Moreover, smart phones (e.g. iPhone®), tablets (e.g. iPad® or iPod® Touch) could also be used to interact via a wireless connection with the microcontroller and the instrument.

In some embodiments, the light source may be electronically connected to the trigger electronics, control circuit, and to the power supply. Commercially available pulsed light sources, such as laser diodes, light-emitting diodes, and diode-pumped solid-state lasers, can be used.

In some embodiments, the detector may be electronically connected to the detection electronics, optional gain control circuit, and the power supply. Commercially available photodiodes, avalanche photodiodes, metal channel photomultiplier tubes, traditional photomultiplier tubes, or linear or two-dimensional charge coupled device arrays can be used for the described apparatus.

In some embodiments, coupling optics may be assembled within a mount. In some embodiments, the mount may be affixed to the light source. In some embodiments, the mount may be affixed to the detector. In some embodiments, the mount may be affixed to the light source and the detector. In some embodiments, the mount contains an optional filter.

In one particular embodiment, a 2 inch DCX lens with a focal length of 100 mm (NT48-260) from Edmund Optics and a 1 inch positive meniscus lens (LE1234-A) from Thor Labs was used to focus LED into the fiber end. In one particular embodiment, a 6-mm diameter hemispherical ball lens (NT45-935) from Edmund Optics was used to focus the emission light from the fiber onto the detector window. This lens was secured with UV curable optical epoxy.

In some embodiments, the components of the control unit may be assembled into a single housing.

In some embodiments, the stem comprises waveguides. Suitable commercially available waveguides are optical fibers. Preferred commercially available waveguides are polymer-clad, multi-mode optical fibers. For applications with sensor dyes absorbing and emitting in the visible spectral regions, both fiber core and cladding materials should be chosen that minimize their intrinsic absorbance, particularly for applications where the light pulses have to travel a long distance through optical fibers between sensor junctions, light source and detectors. For sensors dyes absorbing in the spectral regions between 300 nm and 400 nm (ultraviolet spectral region), polymer claddings are available with reduced intrinsic absorbance, although the absorbance will be somewhat larger than that in the visible spectral region. Pure silica is preferred for the fiber core material for lowest possible intrinsic absorption these spectra regions; impurities in the fiber core material will cause unwanted losses due to their absorption of the light pulses. Waveguide other than optical fibers have to be created via deposition and chemical etching processes, photolithography, etc.

In some embodiments, the ends of the waveguides may be prepared by cleaving, polishing, and connectorizing as necessary. For optical fibers, suitable connectors are widely available commercially. In some embodiments, the excitation terminus of the first waveguide is optically coupled to the light source. In some embodiments, the signal terminus of the second waveguide is optically coupled to the detector.

In some embodiments, portions of the optical fibers where junctions will be located are stripped of their cladding and cleaned. A combination of chemical and heat treatments can be used. One with skill in the art will appreciate the variety of mean of accomplishing this stripping. In some embodiments, waveguides can be fabricated by deposition and chemical etching processes, photolithography, etc. such that the core material is already exposed and ready for attachment of the junction.

In some embodiments, the optical fibers are mounted to form cross-fiber intersections. The procedures used in Examples 4 and 5 are preferred. In embodiments prepared by deposition, chemical etching, or photolithography, the waveguides may be affixed such that mounting is not needed.

In some embodiments, the junctions are prepared by preparing and applying precursor solutions to the cross-fiber intersections and curing the polymers contained therein. The procedures used in Examples 1 and 3 are preferred.

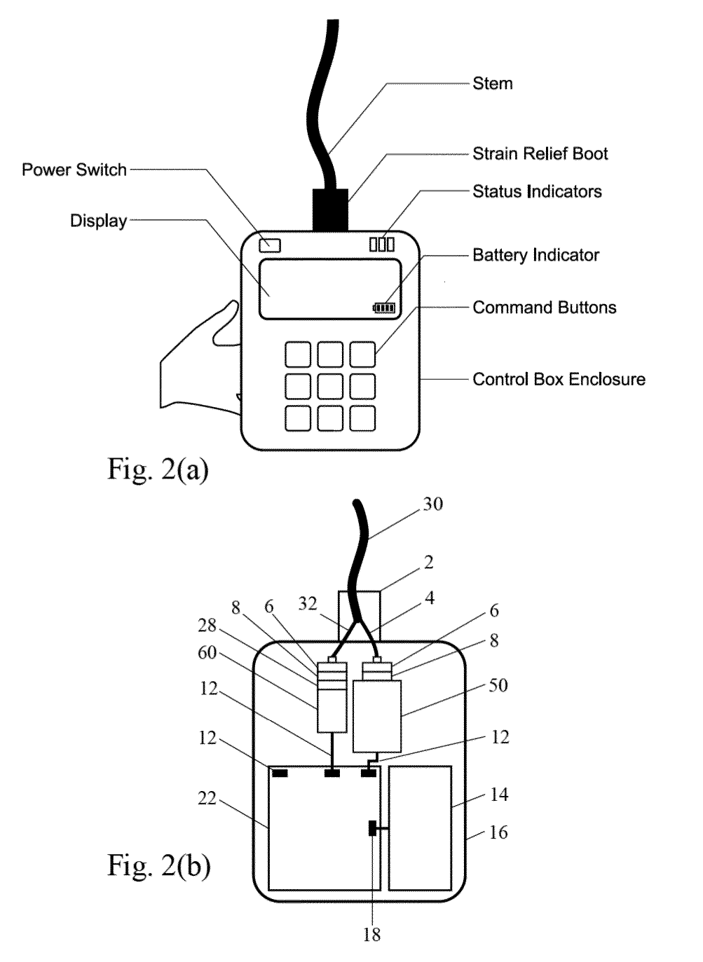

In FIG. 2(b), the handheld apparatus is shown without the optical time of flight sensor array, which is attached to the stem 30. A control unit housing 16 is shown containing a light source 50, a detector 60, a battery 14 and a printed circuit board 22 containing microcontroller and boxcar integrator, trigger, power supply, and detector gain control circuits. The printed circuit board has an electrical connector 12 to interface with a display, command keys, status indicators, and a power switch. An electrical connector 12 is shown between the battery 14 and the printed circuit board 22, between the printed circuit board 22 and the detector 60, and between the printed circuit board and the light source 50. The stem 30 interfaces with the control unit housing 16 via a strain relief boot 2. Within the strain relief boot 2, the stem 30 interfaces with an excitation optical fiber 4 and a detection optical fiber 36.

### Example 1

### Porous Sensor Junctions and Improved Response Time

Dry polystyrene microspheres with a 950 nm mean diameter were purchased from Bangs Labs (Fishers, Ind.). Acetone, ethanol, toluene, and poly(ethylene glycol) diacrylate with a number-average molecular weight (Mₙ) of 575, 2,2-dimethoxy-2-phenylacetophenone, and acryloyl chloride were purchased from Sigma-Aldrich (Milwaukee, Wis.). Fluorescein acryl amide (FAA) was synthesized according to the literature [Sloan and Uttamlal, 1997] using acryloyl chloride and fluoresceinamine, Isomer I from Research Organics (Cleveland, Ohio). Optical fiber with a 200 μm core diameter and high OH content (FT-200-UMT) was purchased from Thor Labs, Inc. (Newton, N.J.).

First, to create the sensor element, small sections of the fiber cladding were removed from a fifteen-m-long excitation fiber and a six-meter-long detection fiber. A thin sheet of aluminum with an eleven mm diameter hole was used as a mask to precisely control the length and position of the section where the cladding was removed. The optical fiber was placed on top of the metal mask, centered across the hole, and secured with cellophane tape. The buffer and cladding layers were thermally removed using a butane lighter positioned approximately six centimeters below the metal mask. The optical fiber was heated for no longer than ten seconds to prevent thermal damage to the fiber core. Next, the stripped sections were removed from the mask, cleaned with an acetone-soaked KimWipe™, and allowed to dry in air. Afterwards, the fibers were mounted in shallow, orthogonal grooves machined into a polypropylene block for further work.

A precursor solution of the probe sensor and probe polymer was prepared with 5.0 mg of fluorescein acryl amide (pH fluorosensor), 10.0 mg of the polystyrene microspheres, 5.0 μL of ethanol (to aid dissolution of the fluorosensor), 160.0 μL of distilled water (to control the refractive index of the cured polymer), and 240.0 μL of PEGDA-575 (polymer) containing 1% (w/v) 2,2-dimethoxy-2-phenylacetophenone (photoinitiator). The precursor solution was mixed for five minutes using a vortex mixer. A 0.5 μL droplet of the precursor solution was placed on the probe junction using an automatic pipette. The polymer was cured for thirty seconds using a PTI Xenon arc lamp operating at 75W (Birmingham, N.J.). The junction was submerged in toluene for 48 hours to remove the microspheres and then allowed to air dry for one hour. The probe junction was stored in distilled water to prevent cracking and deformation as the coating dries.

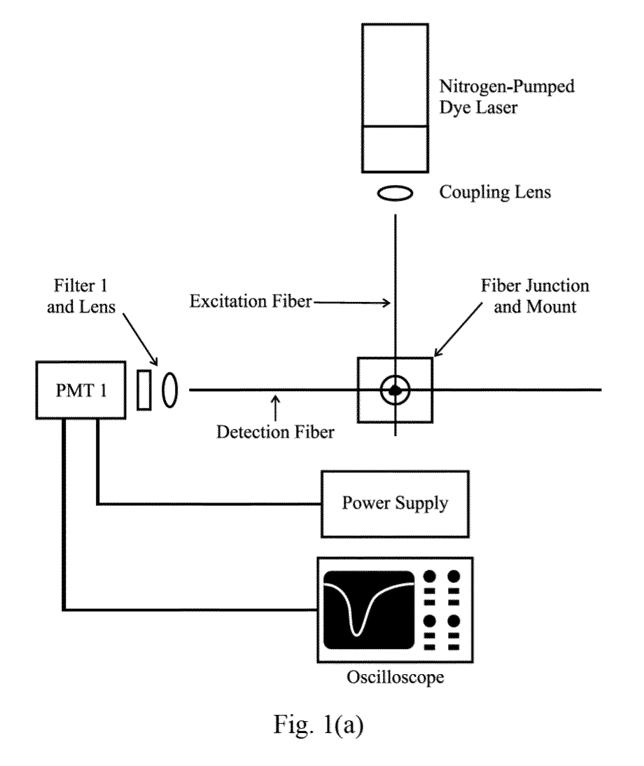

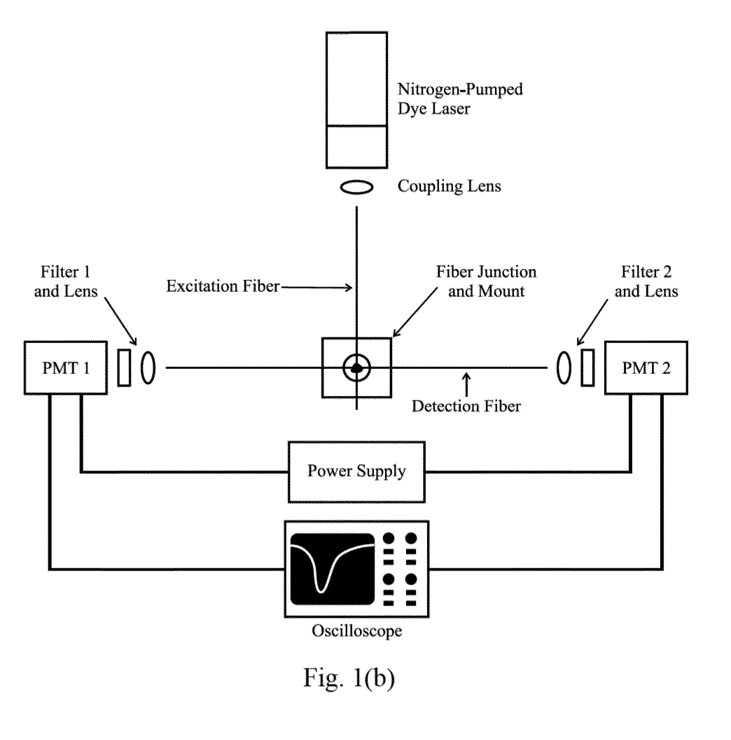

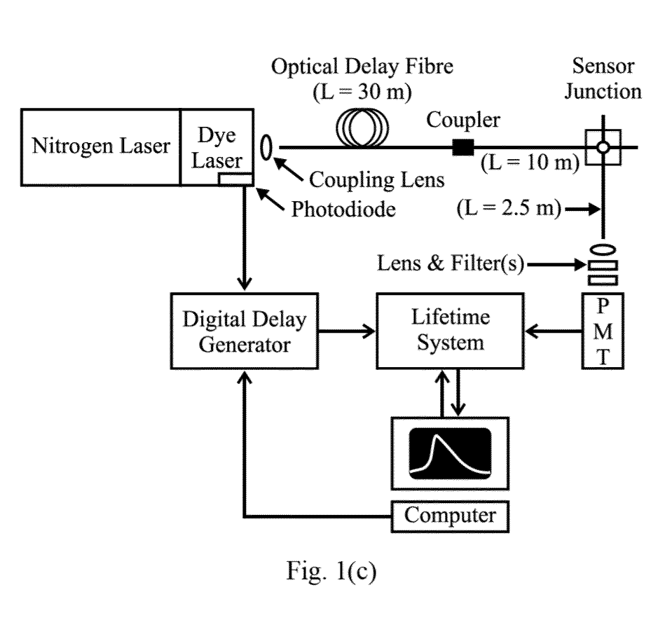

The optical setup is shown in FIG. 1(b). A PTI nitrogen-pumped dye laser (Birmingham, N.J.) provided 465.0 nm excitation light. Two Hamamatsu H6779-20 photomultiplier tubes (PMTs) were employed to simultaneously record the emission and excitation intensities; the excitation signal was used to compensate for source fluctuations. Each end of the detection fiber was connected to a PMT with a mount containing a collimating lens and filter from Edmund Optics (Barrington, N.J.). The fluorescence signal was collected with a 515 nm longpass (OG515) filter, and the excitation signal was collected with a 467-nm interference filter with a 10 nm FWHM bandpass. The excitation and emission intensities were recorded and internally averaged with a LeCroy 1-GHz digitizing oscilloscope (Chestnut Ridge, N.Y.). The oscilloscope averaged twenty laser pulses for response-time measurements and 300 laser pulses for pH measurements of the scattered excitation light. The waveforms were numerically integrated, and emission-excitation intensity ratios were calculated with a LabVIEW routine.

Equation (1) was derived from the Henderson-Hasselbalch relation for use with the emission-excitation intensity ratios

$$pH = {pK}_{a} + log ( \frac{R - {R}_{A}}{{R}_{B} - R} ) . \qquad ( 1 )$$

R is calculated as the ratio of the integrated emission intensity detected at one end of the detection fiber (see FIG. 1(b)) and the integrated excitation signal intensity measured at this fiber's other end. R_{A} is the measured emission-excitation ratio for the acidic form of the luminescent sensor (here the fluorescein monoanion), R_{B} is measured emission-excitation ratio for the basic form of the luminescent sensor (here the fluorescein dianion), and the pKₐ is the acid dissociation constant of the luminescent sensor. Nonlinear least-squares regression was performed with the experimental data and (1) using OriginPro Version 7.0.

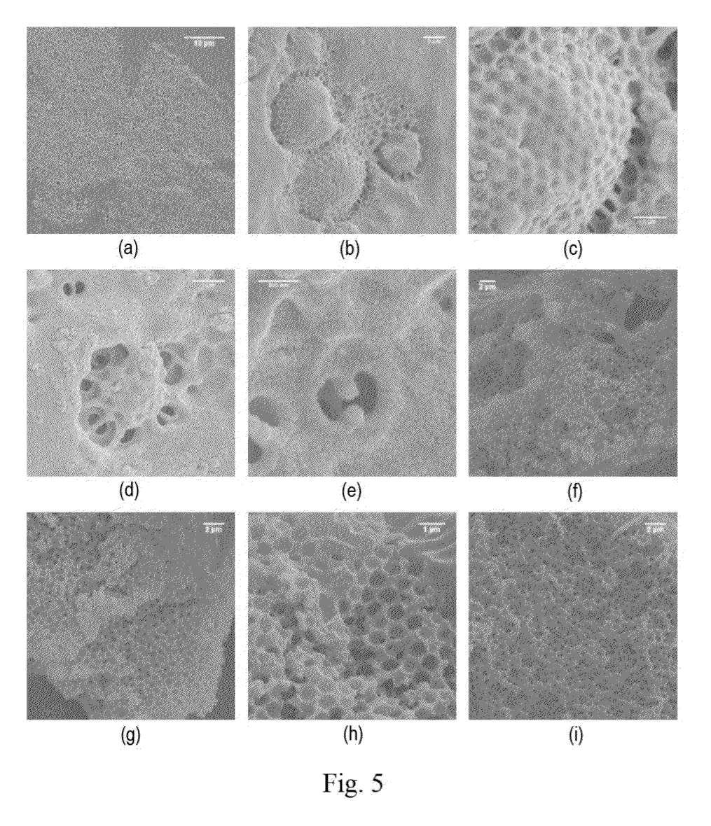

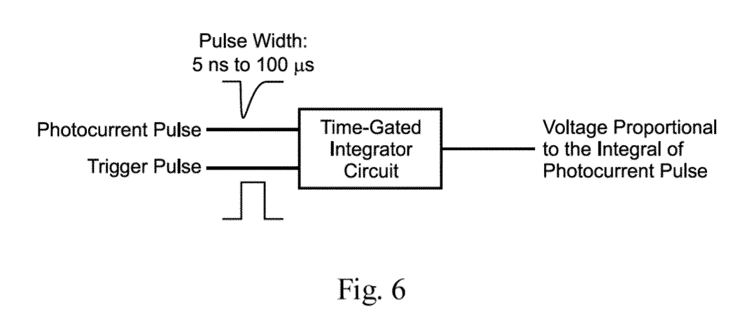

Several probe polymers were prepared with the templated PEGDA polymer for SEM imaging. Also, some probe polymers were cleaved with a razor blade to examine the internal structure of the templated polymer. As shown in FIG. 5, the microsphere templating technique created an interconnected pore network that extends throughout the replacement cladding material. Also, strong microsphere aggregation was evident in the images. This behavior is expected because the microspheres are hydrophobic and PEGDA is hydrophilic. Although some areas resemble a hexagonal close-packed structure, microsphere aggregation did not result in a highly ordered pore network. This random pore orientation is expected since no effort was made to tightly pack the microspheres. Such a dense, highly ordered arrangement is expected to be detrimental to the mechanical stability of the polymer framework after microsphere dissolution; recall that the framework structure has to lock the two fibers at the sensor junction rigidly in place. Any movement of the fibers could lead to unwanted changes in the measured sensor signal: the exponential drop off of evanescent fields implies that small distance changes lead to exponentially amplified changes in the evanescent field strength. Ultimately, the most crucial figure of merit is the rate of analyte penetration. Even though the disordered channel structure varies between samples, their analyte penetration rates are reproducible.

On the surface of the probe polymer, microsphere aggregation created regions with high pore density and regions with low pore density, like that shown in FIG. 5(a). Also, microsphere aggregation resulted in the three-dimensional dome structures with pores formed below the surface (FIGS. 5(b) and 5(c)). FIGS. 5(d) and 5(e) show the pillars formed where the PEGDA polymer filled the void between three aggregated microspheres. These images also show pore formation below the surface of the polymer coating.

The cross-sectional images from the cleaved junctions, FIGS. 5(f) through 5(h), show that pores were formed throughout the structure. In addition, these images show a higher degree of microsphere aggregation resulting in a denser pore network, resembling a sponge. This pore network should accelerate diffusion of an analyte through the PEGDA-based replacement cladding to the sensor molecules located near the fiber core and therefore yielding an improved response time of the sensor.

Response times were measured to determine if the pore network accelerated transport of an analyte through the probe polymer. A non-templated probe junction was created to provide a reference time value for comparison. The response times were measured by submerging the probe junctions into phosphate buffer solutions under static equilibrium (i.e., no stirring). The luminescent sensor has a pH-dependent response over a pH range from four to ten, resulting from an increase in both absorbance and fluorescence quantum yield when the pH is increased.

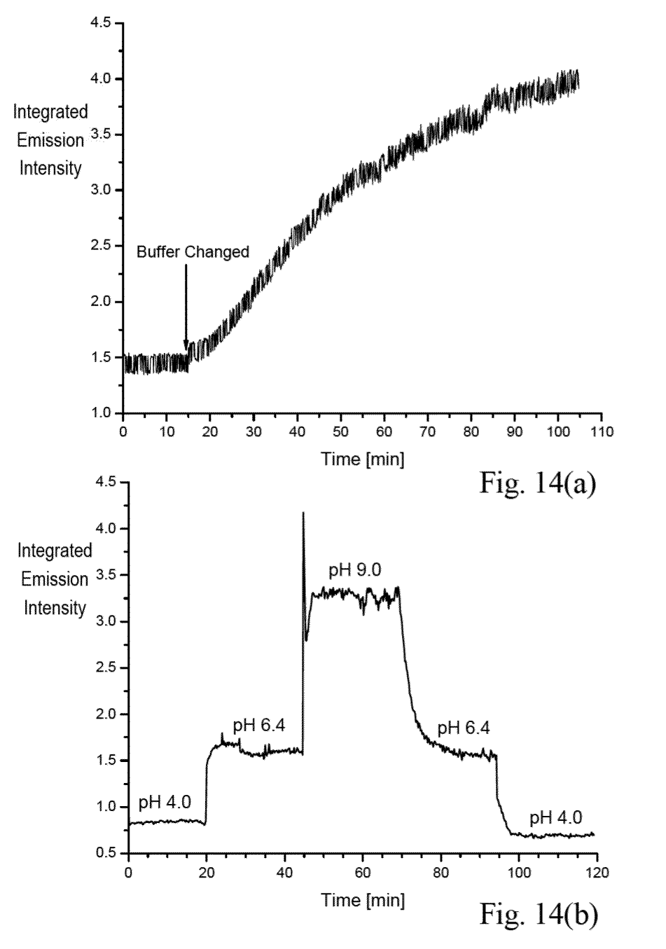

The response-time traces shown in FIG. 14 demonstrate that microsphere templating improves response time significantly. For the non-templated sensor junction, the change in fluorescence was gradual and the time to reach equilibration was in excess of 100 minutes. Conversely, the templated probe junction had a rapid initial response followed by an equilibration time of ten minutes. Thus, the pores formed by microsphere templating increase diffusion of the analyte to the probe compound near the fiber core, yielding a tenfold improvement in the sensor response time.

As the pore network increases diffusion of the analyte throughout the probe polymer, increased leaching of the probe compound is expected. Leaching can be minimized by covalently attaching the probe dye to the polymer matrix. Here, the pH sensor was covalently tethered to PEGDA during photopolymerization.

### Example 2

### Time-Correlated Single Photon Counting and Stroboscopic Detection Methods

### Sensor Preparation

Quasi-distributed optical fiber sensor arrays containing luminescent sensor molecules can be read out, spatially resolved utilizing optical time-of-flight detection (OTOFD) methods, which employ pulsed laser interrogation of the luminescent probe and time-resolved detection of the probe signals. In many cases, sensing is based on a change in the probe compound's luminescence intensity; however, sensing based on luminescence lifetime changes is preferable because it reduces the need for field calibration. Because in OTOFD detection is time-resolved, luminescence-lifetime information is already available through the signal pulses, although in practice applications were restricted to sensors with long luminescence lifetimes (hundreds of ns). To implement lifetime-based sensing in crossed-optical-fiber-sensor arrays for probe molecules with lifetimes less than 10 ns, two time-domain methods, time-correlated single photon counting and stroboscopic detection, were used to record the pH-dependent emission of a fluorescein derivative covalently attached to the highly-porous probe polymer. A two-term nonexponential decay function yielded both a good fit for experimental lifetime data during reconvolution and a pH response that matches Henderson-Hasselbalch behavior, yielding a probe accuracy of 0.02 pH units. Moreover, strong agreement was obtained for the two lifetime determination methods and with intensity-based measurements taken previously.

The procedure of Example 1 was repeated to produce a probe junction. Time-resolved fluorescence measurements were recorded while the probe junction was submerged in various buffer solutions. A McIlvaine-buffer was used for a pH range from 4 to 8, a 0.1 M tris-buffer was used at pH 9 and a 0.1 M phosphate-buffer was used at pH 12. The junction was submerged in distilled water between measurements.

### Optical Setup

The same optical setup was used for both lifetime systems, as shown in FIG. 1(c). Multiple measurement parameters were matched so that a direct comparison could be made of both lifetime techniques. A PTI GL-302 nitrogen pump laser was used in conjunction with a PTI GL-3300 dye laser as the excitation source (Photon Technologies International, Birmingham, N.J.). Coumarin 460 (7-(diethylamino)-4-methyl-2H-1-benzopyran-2-one) in ethanol was used to provide an excitation wavelength of 465.0 nm (Exciton, Dayton, Ohio). Also, the dye laser contained a photodiode for triggering both detection systems. The excitation pulse was coupled into a 30 m long fiber that served as an optical delay required by the stroboscopic system. This light was coupled into the excitation fiber of the probe junction where the 10 m length allowed for depletion of light launched into lossy modes of the fiber [Ma and Bock, 2007; Pask and Snyder, 1976]. The probe response was collected by the detection fiber and coupled to the photomultiplier detector with a lens and one or more optical filters. Narrow bandpass filters were used in lieu of a monochromator. Instrument response functions (IRF) were recorded using a 467 nm narrow bandpass filter, and the emission decay curves were recorded using a 515 nm narrow bandpass filter (Edmund Optics, Barrington, N.J.). The detection systems used for both lifetime techniques are described in the following paragraphs.

TCSPC data was acquired with a Becker and Hickl SPC-130 TCSPC module and DEL-350 DDG (Berlin, Germany). A 100 ps time bin width was chosen to match the fixed time window of the stroboscopic system. The digital delay generator (DDG) delay value was empirically determined using an initial estimate from the optical delay from 40 m of fiber (200 ns) and the TCSPC observation window width (100 ns); the TCSPC observation window was included because the TCSPC module was operated in reverse start-stop mode. Coaxial cable length was minimized to reduce signal loss and electromagnetic interference. A Hamamatsu H5773-20 PMT detector, optimized for photon counting, was used for all TCSPC measurements. The optimum discriminator value for the TCSPC module was determined using a procedure given in the literature [Niemczyk et al., 1979] with the PMT gain set to approximately 80% full scale. Absorptive neutral density filters were used to maintain a count rate of one photon for 20 or more excitation pulses in order to meet Poisson criteria for photon counting and to minimize photon pile-up effects.

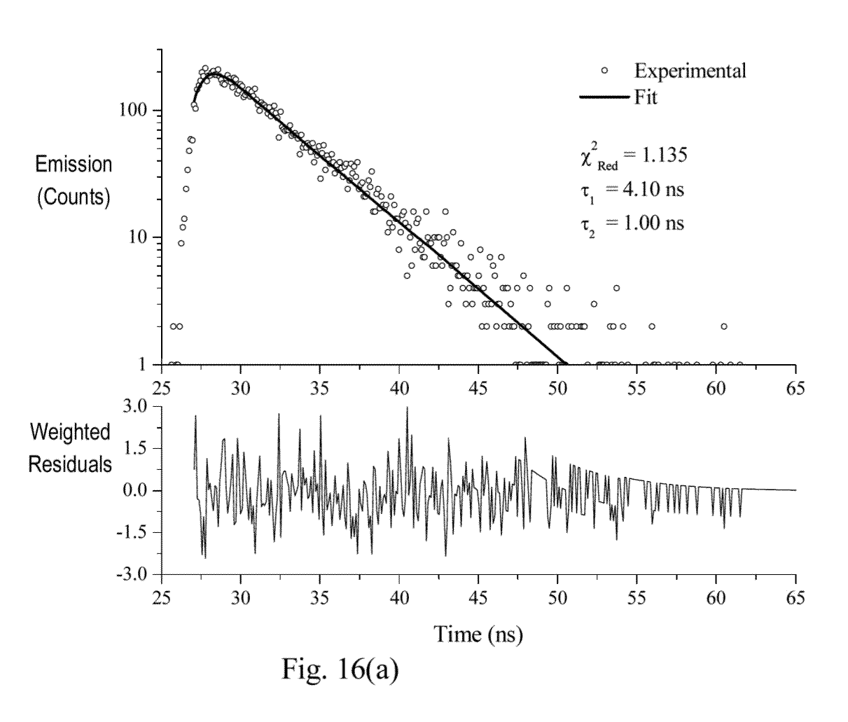

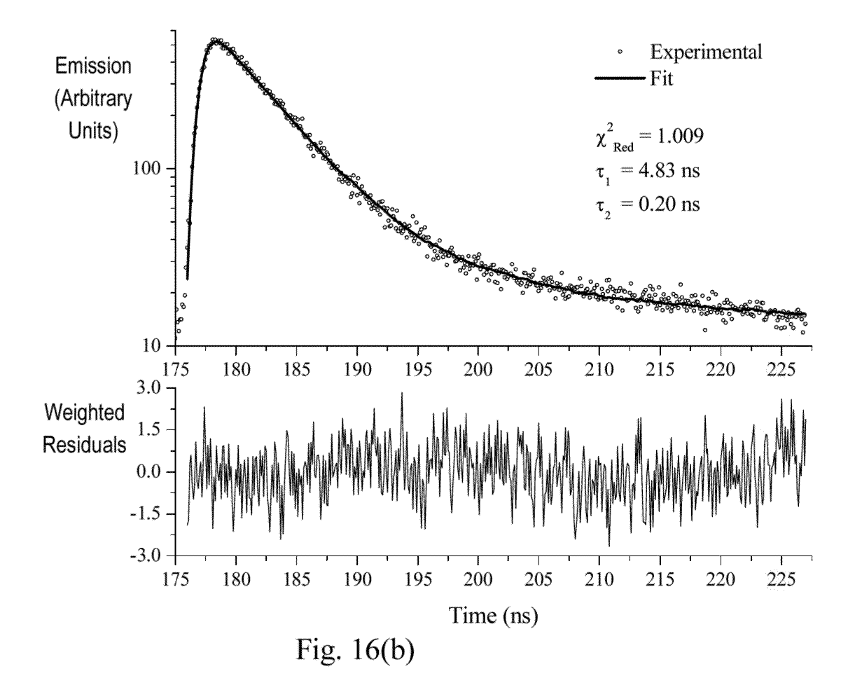

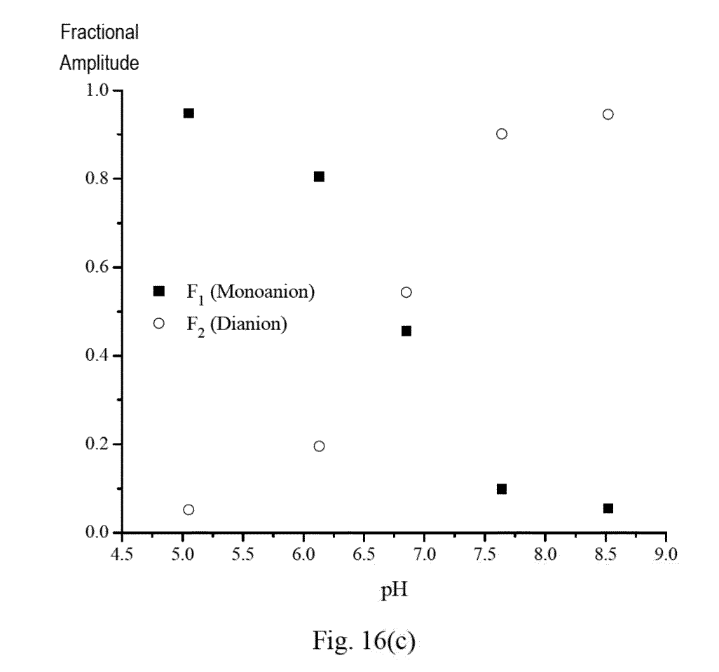

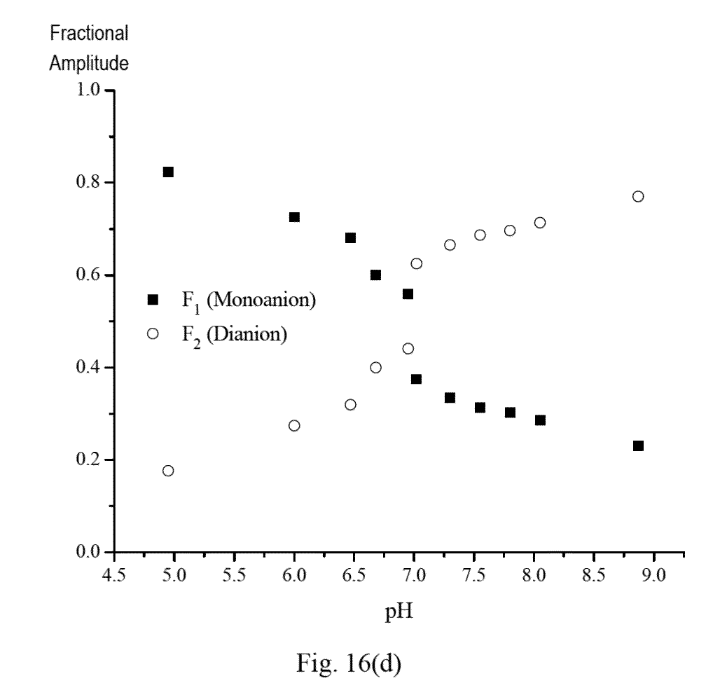

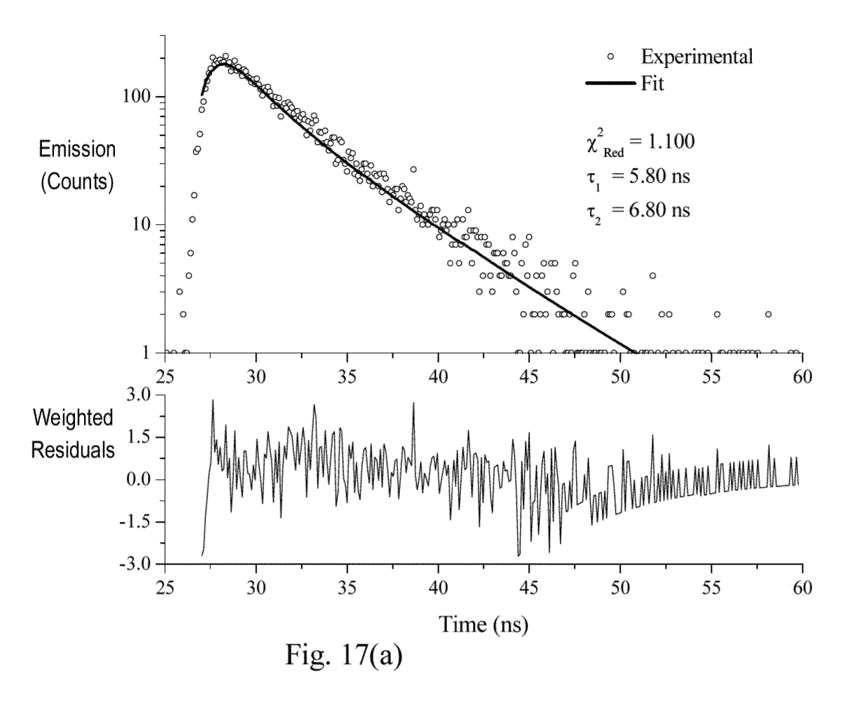

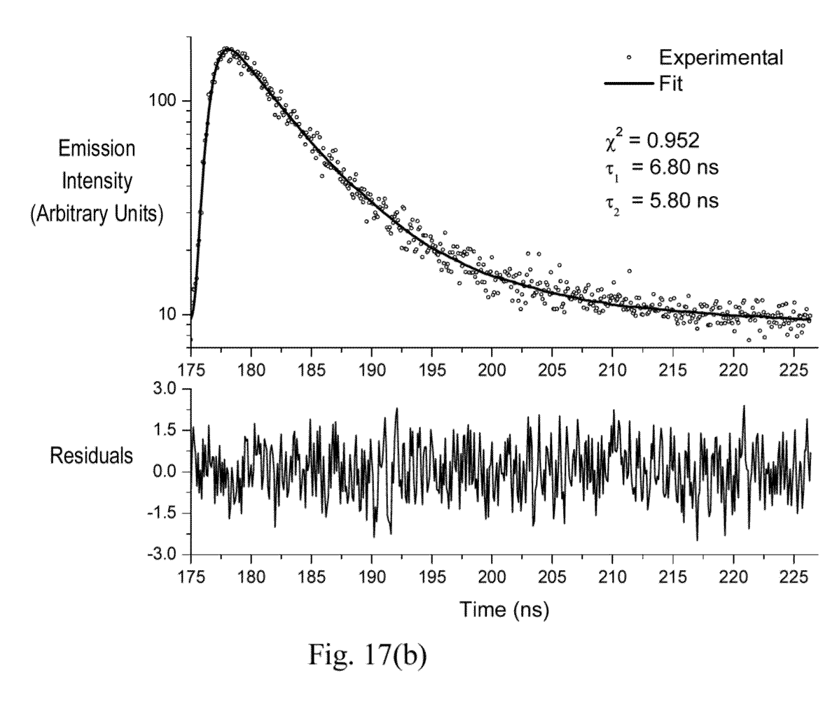

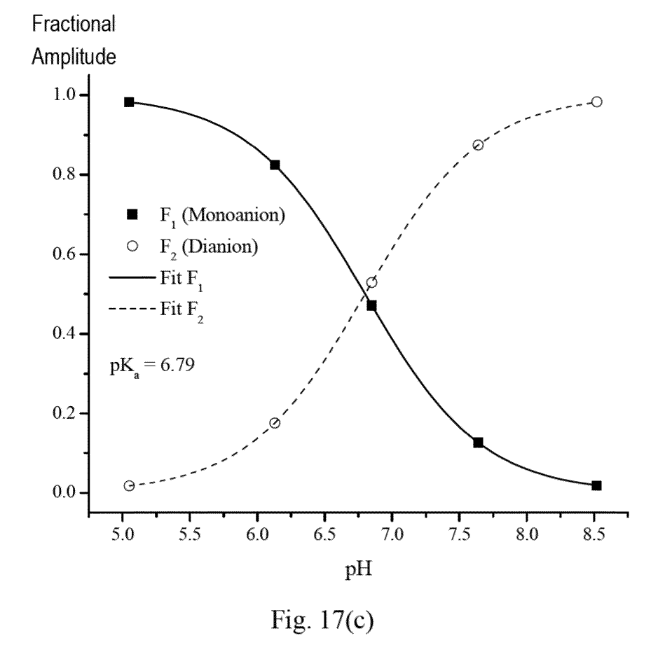

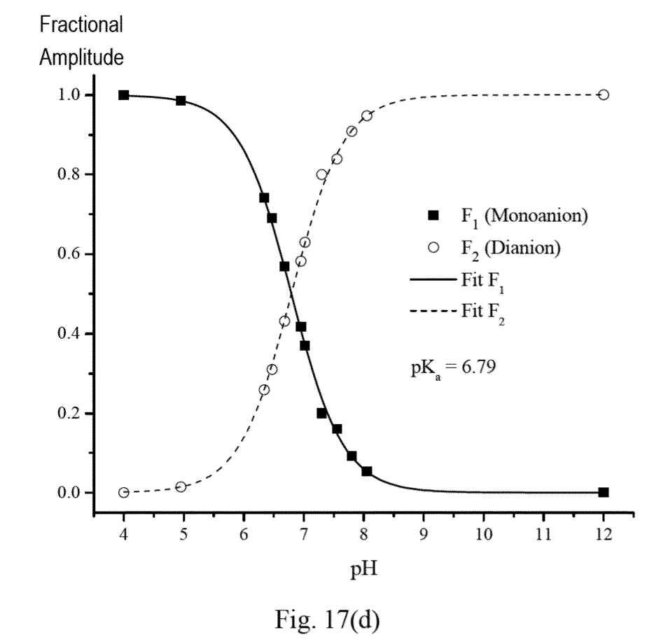

Stroboscopic lifetime measurements were recorded with a modified PTI LaserStrobe™ Fluorescence Lifetime Spectrofluorometer. The LaserStrobe™ system was configured with the nitrogen-pumped dye laser described in section 2.2 as the excitation source. The LaserStrobe™ detection system included a DDG, avalanche circuit, stripline circuit and Hamamatsu R1527PMT and was used without modification. The fiber-probe junction was coupled to the excitation source and detector in a similar manner to TCSPC system described above. A cylindrical lens was added to the optical system to increase coupling of light into the detector. The stroboscopic system was interfaced to a PC with the PTI's FeliX32™ data acquisition and analysis software. Data was recorded in 100 ps time intervals over a 55 ns observation window. The fixed 100 ps gate window was scanned in a random order (opposed to sequential order) to compensate for short-term drift and shot-to-shot fluctuations of the nitrogen laser source. Likewise, signal averaging was performed by the software. For each curve shown in FIGS. 16(a) and 17(a), five datasets were averaged where each point within one dataset is the average of five excitation pulses.

### Reconvolution Analysis

The lifetime parameters were recovered by reiterative convolution (reconvolution) with a weighted, nonlinear least squares method using the measured IRF and emission decay data [Grinvald and Steinberg, 1974; McKinnon et al., 1977; O'Connor et al., 1979]. Two regression analyzes were performed with the TCSPC and stroboscopic lifetime data. First, reconvolution was performed with a biexponential decay function using FeliX32™. Later, reconvolution was performed with a two-term nonexponential decay function. This required a custom OriginC routine as this decay function was not available in commercial fluorescence lifetime analysis software (OriginPro 8.0 SR6, OriginLab, Northampton, Mass.). The OriginC code is available in the supplementary information available at stacks.iop.org/MST/23/045104/mmedia.

The reduced chi-squared values and plots of weighted residuals were used to determine the ‘goodness of fit’ between the calculated and measured decay curves [Irvin et al., 1981]. The standard Poisson weighting scheme was used for the TCSPC data where the standard deviation of each time bin is the square root of the count value. A standard deviation of 1 was assigned to empty time bins to avoid catastrophic division-by-zero errors in analysis [Nishimura and Tamura, 2005]. Since the stroboscopic method is an analog measurement, the standard deviations are not known a priori. The standard deviations and weighting factors for the stroboscopic data were estimated using the ‘9-3’ method published previously that yields reduced chi-squared values and residual patterns similar to Poisson weighted data [James et al., 1992].

### Results

Fluorescein was chosen as a pH probe because its spectral properties are well-known [Arbeloa, part 1, 1981; Arbeloa, part 2, 1981; Gao et al., 2002; Leonhardt et al., 1971; Martin and Lindqvist, 1975; Smith and Pretorius, 2002]. Here, a fluorescein derivative was covalently attached to the probe polymer to minimize leaching caused by the extensive pore network in the polymer [Sloan and Uttamlal, 1997, Munkholm et al., 1986; Wallace et al., 2001]. With a dissociation constant (pKₐ) in the range of 6.7 to 6.8, deprotonation of the monoanion species results in a large change in absorbance and increase in fluorescence quantum yield. Given that the monoanionic and dianionic forms of fluorescein are both emissive, two fluorescence lifetimes are expected. Thus, a biexponential decay function (equation (2)) was chosen initially to analyze the lifetime data:

$$d ( t ) = {y}_{0} + {\sum }_{i = 1}^{2} [ {A}_{i} exp ( - \frac{t - {t}_{s}}{{τ}_{i}} ) ] \qquad ( 2 )$$

d(t) is the decay function where A₁ and A₂ are the exponential prefactors, τ₁ and τ₂ are the fluorescence lifetimes (in ns) of the monoanionic and dianionic forms of the fluorescein-based sensor, t is the time (in ns), tₛ is the PMT color-shift parameter (in ns) and y₀ is a baseline offset. The color shift parameter was empirically determined and fixed during regression. Also, y₀ was fixed to zero for the TCSPC data as the background counts were low. Because the stroboscopic method is an analog measurement, y₀ was allowed to vary to account for baseline differences. The corresponding fractional amplitudes, F₁=A₁/(A₁+A₂) and F₂=A₂/(A₁+A₂), represent the monoanion and dianion concentration values of sensor and can be substituted into the Henderson-Hasselbalch relation for acid-base equilibria:

pH=pKₐ+log(F₂/F₁) (3)

Here, pKₐ is the negative logarithm of the acid dissociation constant of the fluorescein monoanion.

It is important to note that the recovered parameters in this work are treated as purely empirical fitting parameters in order to demonstrate a fluorescence lifetime-based approach to sensing by measuring pH. Although there is a physical basis for the selection of decay functions and input parameters, the physical significance of the recovered values may be limited as these lifetimes may not accurately reflect the true decay kinetics of the system. Consequently, the recovered lifetimes can be referred to as ‘apparent lifetimes’; with these apparent lifetimes, pH measurement can be carried out using the calibration curves reported here.

Sample reconvolution results with the biexponential decay function are shown in FIGS. 16(a) and 16(b). A good fit was obtained with the measured time-resolved fluorescence data for both lifetime methods, which is also supported by the reduced chi-squared values given in Table 1. Also, the plots of the weighted residuals are randomly distributed, indicating a satisfactory fit to the experimental data, although a slight oscillation was present in some samples. Finally, both methods yielded similar apparent fluorescence lifetimes: approximately 4 ns for the monoanion and approximately 1 ns for dianion (Table 1).

TABLE 1
Summary of recovered parameters from reconvolution of the TCSPC and the stroboscopic data.

| | | TCSPC | Stroboscopic | TCSPC | Stroboscopic |
|---|---|---|---|---|---|
| Parameter | | biexponential | biexponential | nonexponential | nonexponential |
| Monoanion lifetime | τ₁ | 4.10 ns | 4.38 ns | 5.80 ns | 5.80 ns |
| Dianion lifetime | τ₂ | 1.00 ns | 0.20 ns | 6.80 ns | 6.80 ns |
| Colour-shift | tₛ | +1.0 ns | −44 ps | +1.1 ns | −65 ps |
| Monoanion interaction strength | B₁ | | | 1.85 | 0.252 |
| Dianion interaction strength | B₂ | | | 4.00 | 1.266 |
| χ_{Red}² range | | 0.999 to 1.523 | 1.009 to 1.733 | 1.030 to 1.479 | 0.951 to 1.437 |

The corresponding fractional amplitudes from the analysis are shown in FIGS. 16(c) and 16(d). Although the pH response was sigmoidal, the response deviated from the Henderson-Hasselbalch relation (equation (3)). These deviations are most evident with the stroboscopic data and are less pronounced with the TCSPC data, which only contained five samples. Both TCSPC and the stroboscopic method are complementary time domain techniques, and thus should yield similar results. This suggested that the biexponential decay function was unsuitable for measuring pH accurately and that a more complex decay model was needed.

When a luminescent compound is immobilized into the probe polymer matrix, the luminescent compound is influenced by its surrounding microenvironment. Subsequently, these luminescent compound-probe polymer interactions will result in a distribution of fluorescence lifetimes. It has been reported that these interactions can be modeled with a nonexponential decay function [Draxler and Lippitsch, 1996; Draxler et al., 1995].

Hence, a two-term nonexponential decay function was selected for the two emissive forms of fluorescein:

$$d ( t ) = {y}_{0} + \sum [ {A}_{i} exp ( - \frac{t - {t}_{s}}{{τ}_{i}} ) {exp ( - {B}_{i} \frac{t - {t}_{s}}{{τ}_{i}} )}^{1 / 2} ] . \qquad ( 4 )$$

The additional parameters, B₁ and B₂, are the fluorophore-polymer interaction strengths resulting in nonexponential behaviour. Again, the fractional amplitudes can be substituted into equation (3) to determine the pH response. The sample reconvolution results with the two-term nonexponential decay function are shown in FIG. 17. Again, visual inspection of the sample decay curves and the plots of the weighted residuals, and the reduced chi-squared values (Table 1) indicate that a good fit was obtained with the nonexponential decay function for both lifetime methods. Furthermore, the slight oscillation is no longer present in the plots of the weighted residuals (FIG. 16(a) versus FIG. 17(a) and FIG. 16(b) versus FIG. 17(b)) signifying an improved fit with the nonexponential decay function. Note that the two apparent lifetimes of 5.80 and 6.80 ns were recovered from reconvolution of the stroboscopic data and were subsequently fixed during reconvolution of the TCSPC data.

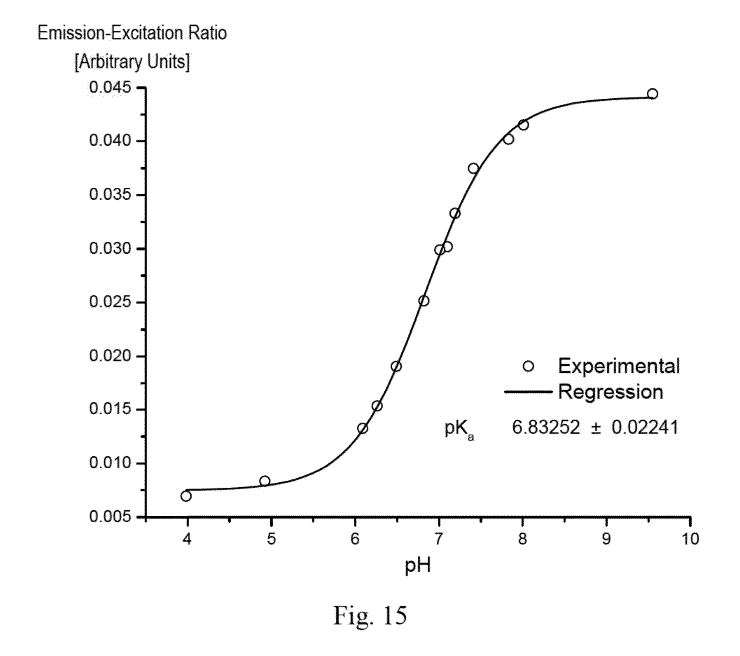

Finally, the corresponding fractional amplitudes from the analysis with the nonexponential function are shown in FIGS. 17(c) and 17(d). For the stroboscopic data, the pH response improved dramatically and agrees well with the Henderson-Hasselbalch relation. Analysis with the nonexponential decay function showed improvement for the TCSPC data as well, although the improvement is less pronounced with only five samples in the TCSPC dataset. Furthermore, regression with the fractional amplitudes and the Henderson-Hasselbalch relation yielded a pKₐ of 6.79 for both lifetime methods. Also, the pKₐ values from the lifetime-based measurements agree well with intensity-based measurements taken previously (FIG. 15).

The accuracy of the sensor system was estimated from the pH deviations with respect to a validation method. First, the pH of the buffer solutions was measured with a conventional pH electrode with a specified accuracy of 0.05 pH units. The pH deviations were determined from the pH electrode measurements and the pH values determined from the regression data (FIGS. 17(c) and 17(d)) and equation (3). The pH deviations were 0.02 pH units or lower for the TCSPC method. For the stroboscopic method, the largest pH deviation was 0.09 pH units (at pH 7.3), and all other pH deviations were 0.02 pH units or lower. Thus, the accuracy of pH measurements was estimated to be 0.02 pH units for TCSPC and 0.09 pH units for the stroboscopic method.

Theoretically, both time-domain lifetime techniques are complementary and, thus, should provide equivalent results. The recovered parameters can be examined to evaluate measurement consistency and to compare both detection methods. For pH measurements, the pKₐ can be used as evaluation criteria of the sensor response. The pKₐ of covalently-attached fluorescein was experimentally determined to be 6.79 for both TCSPC and stroboscopic detection, indicating that both lifetime methods provided similar results. Moreover, this value is similar to the pKₐ of 6.83 determined previously with the pH sensor using an intensity based measurement technique. In addition, the observed pKₐ compares well to values reported in the literature. For FAA covalently attached in a similar polymer matrix, Wallace et al observed a pKₐ of 6.57 for an evanescent sensor and 7.85 for a distal sensor, and suggested that the difference was possibly due to the effect of the polymer environment [Wallace, 2001]. Munkholm et al [Munkholm, 1986] reported an approximate pKₐ of 6.2 while Sloan and Uttamlal [Sloan and Uttamlal, 2002] reported a pKₐ of 7.4. In all of these cases, the pH sensor was immobilized in different polymers, and different excitation and emission wavelengths were used.

Global reconvolution analysis of the stroboscopic data was performed first, because this dataset was larger than the TCSPC dataset. In the analysis, all of the decay curves in the stroboscopic dataset were analyzed simultaneously using the lifetimes, interaction strengths and color-shift parameters as shared parameters. That is, this global analysis determined the best-fit value for each shared parameter that applies to all of the decay curves in the stroboscopic dataset. Also, the lifetimes were constrained to be 10 ns or less and the color-shift parameter was empirically determined and fixed during the analysis. The resulting apparent lifetime values were subsequently used as fixed quantities in the TCSPC analysis, and, hence, the apparent lifetimes for both techniques shown in Table 1 are identical. A suitable pH response was obtained for both lifetime techniques using the nonexponential decay function with these apparent lifetimes, even though these values may not accurately represent the true photophysical processes of the system. The recovered values for the polymer-fluorophore interaction strengths, B₁ and B₂, however, are different for the two lifetime techniques. This is most likely the result of the fixed lifetime parameters used in the reconvolution analysis of the TCSPC data, which, given the small size of this dataset, was chosen to reduce the number of variable parameters in the fitting equation (4). Fixing the apparent lifetimes and the color-shift parameter likely caused the reconvolution algorithm to resort to a larger variation of the values of B₁ and B₂ to minimize the reduced chi-squared values and to produce the best fit to the experimental data. Hence, the recovered B₁ and B₂ values should be treated as empirical fitting parameters. The magnitude of the reduced chi-squared values obtained using the nonexponential decay function fall within a range that is considered to be satisfactory. Also, the empty time bins for the TCSPC data were weighted with a value of 1 to avoid division-by-zero errors, and, therefore, the reduced chi-squared values may be elevated. For reconvolution analysis of the stroboscopic data, the weighting factors were estimated using the ‘9-3’ method in order to obtain goodness of-fit parameters similar to Poisson weighted data [James et al., 1992]. As a consequence, reduced chi-squared values less than 1 may occur, and values in the range of 0.9 to 1.5 indicate a satisfactory fit.

The TCSPC dataset only contained five decay curves because the acquisition times exceeded 24 h per dataset. A detection rate of 0.05 photons per excitation pulse was chosen to avoid pile-up effects and to use a Poisson weighting scheme in the reconvolution analysis. The excitation source operated at a pulse-repetition rate of 4 Hertz, and, thus, long acquisition times were required. We choose to use the same excitation source for both lifetime techniques; a higher repetition rate source would be more practical for TCSPC measurements. For comparison, a 1 MHz excitation source would have yielded similar results with an acquisition time of about 400 ms. Also, the stroboscopic method had an acquisition time of approximately 15 min.

Although excitation sources with megahertz repetition rates are available, an upper limit of the source repetition rate exists when OTOFD is employed. OTOFD relies on a reference-time value for correlating the arrival time of an emission pulse at the detector with the position of a single sensor in the array. A triggering photodiode was positioned at the output of the excitation laser to provide this time reference. If more than one excitation pulse is present in the fiber at any time, then the time reference is invalid and therefore, the arrival time of a single fluorescent pulse cannot be accurately correlated to one specific sensor region in the array. Thus, the OTOFD observation window, containing the time-resolved readout of the entire array, determines the maximum repetition rate of the source that can be used. This OTOFD observation window depends on multiple factors, including the length of the optical fibers (i.e. pathlength), the light propagation speed in the optical fiber, the number of probe sensors in the array and the luminescence lifetime of the sensor(s). For example, consider a sensor with a 10 ns fluorescence lifetime is used to create a crossed-fiber junction with a 50 m excitation fiber and 10 m detection fiber. The excitation pulse must first travel through the 50 m excitation fiber to the sensor junction and then the emission pulse must travel through the 10 m detection fiber to the detector, yielding a geometrical pathlength of 60 m. The time-of-flight for the sensor junction can be determined using the geometrical pathlength and the propagation speed of light in the fiber core given as c_{Vac}/n. Using a fiber-core refractive index of 1.46, the corresponding time-of-flight is 292 ns for the single probe region. Also, 100 ns (i.e. ten lifetimes) is allotted for near-complete extinction of the probe's fluorescence. This yields an OTOFD observation window of 392 ns, and thus the maximum source repetition rate is limited to 2.5 MHz. For an array with multiple sensor regions or sensors with longer luminescence lifetimes, the OTOFD observation window becomes longer, and a lower repetition rate would be required.

Modal dispersion is a potential source of error lifetime measurements with fiber sensors. While multimode fiber allows for strong evanescent coupling, the propagation speed of light is not the same for all guided modes. This results in temporal broadening of an optical signal as it propagates through the fiber core known as modal dispersion. Also, as the optical pathlength (i.e. fiber length) increases, broadening of the optical signal will increase, resulting in an exaggerated luminescence lifetime. Because the excitation and emission signals undergo a similar extent of pulse broadening in the optical fiber, the effect of modal dispersion may be accounted for by recording the IRF from excitation light that couples to the detection fiber, as done in this work.

Another potential source of error for lifetime measurements with fiber sensors is a wavelength-dependent time response of the measurement system. Both the color effect of the detector and chromatic dispersion in the fiber can cause a temporal offset between the IRF and measured decay curve, and this offset can yield systematic errors in the results from analysis. PMT detectors exhibit a time response that is dependent on the wavelength of light incident on the photocathode, known as the color effect. The color effect was a significant source of error in early TCSPC lifetime measurements. For the stroboscopic method, however, the color effect may be negligible because the transit time spread of multiplied electrons in the PMT becomes inconsequential when the detector is strobed and the photoresponse is recorded in an analog manner. Chromatic dispersion can also introduce a temporal offset because the propagation speed of light in the fiber core depends on the wavelength of light. The color-shift parameter (tₛ) was used here to compensate for the temporal shift due to both chromatic dispersion and the color effect, and these two effects oppose each other. For the color effect, a blue photon causes a faster response than a red photon, and a positive color-shift value is expected. For chromatic dispersion, the refractive index is lower for a red photon and it should propagate faster in the fiber core than a blue photon, and thus a negative shift value is expected. Examination of the color-shift parameter values in Table 1 suggests that the color effect was not observed for the stroboscopic method, and the effect of chromatic dispersion was small. Likewise, the values for the TCSPC data suggest that the color effect was observed and produced a larger temporal offset because the extent of chromatic dispersion should be similar for both lifetime methods. One method for empirically determining the color-shift parameter is to submerge the bare fiber junction in a pure solvent. The color shift parameter can be determined by the IRF recorded at the excitation and emission wavelengths. Alternatively, the color-shift parameter can be determined by submerging the bare fiber junction in a fluorescence-lifetime standard, and the color-shift parameter can be determined from reconvolution with the fixed, known lifetime and a monoexponential decay function.

Detection of multiple sensor regions with a single TCSPC observation window should be avoided as it may produce an error analogous to the classical pile-up effect. Pile-up effects result from the fact that TCSPC devices can only measure the arrival time of one photon per excitation pulse [Becker, 2006]. If two or more photons are detected in a single excitation pulse (as monitored from the detector output), the TCSPC device only records the first photon and the other photons are lost. Since the loss of the second photon is more likely to occur in the tail end of the signal, the recorded decay curve becomes distorted, and the luminescence lifetime(s) cannot be accurately determined. Therefore, the detection count rate is chosen to be only a few percent of the excitation repetition rate (e.g. one photon detected per 20, 50 or 100 excitation pulses) so that the probability of detecting two photons per excitation interval is low. Another pile-up effect may be observed for an array of sensors using OTOFD. If two sensor regions emit a photon during one excitation cycle, then the TCSPC device will only record the photon from the sensor region with the shortest optical pathlength, and thus, counts will pile-up for sensor regions with short optical pathlengths. It may be possible to use a multi-anode PMT and multiple TCSPC channels to overcome this obstacle. Also, this pile-up effect is not an issue for the stroboscopic technique as it is not a counting measurement.

### Example 3

### Reference Junction

When using pulsed excitation sources, it is expected that there will be fluctuations in intensity from pulse to pulse. In order to correct for this, both the probe sensor and pulse intensities will be measured simultaneously. This correction factor compensates for shot to shot fluctuation as well as instrumental drift over time. Initial intensity measurements were done with a fast photodiode detector located in proximity to the source. As light was coupled into an optical fiber, the scattered radiation was measured using the photodiode. However, it became clear that there were other signal losses occurring within the fiber which needed to be accounted for. These losses can stem from bends in an optical fiber, modal dispersion or the transmission capability of an optical fiber being wavelength dependent. A second sensor, acting in the same reference capacity as the fast photodiode, was employed to account for intensity fluctuations.

In order to have an effective reference, the material used must be resistant to all chemical species. There are several methods to achieve this. One method includes encapsulating the luminescent material within a dense polymer such as polyacrylonitrile, in effect shielding the material from interfering species. One luminescent material, referred to as Dragon Green and commercially available from Bangs Laboratory, Inc.™, Fishers, Ind., consists of polymer microspheres injected with a luminescent dye. Both of these classes of luminescent materials have demonstrated a resistance to signal changes in the presence of chemical species.

A probe junction was prepare according to the procedure of Example 1 and a reference junction was prepare according to the same procedure, but with a precursor solution containing 60 parts by volume of PEGDA 575 containing 1% DMPA (w/v), 5 parts by volume of TPT, 25 parts by volume of distilled water, and 10 parts by volume of an undiluted Dragon Green microsphere suspension (1% solids content) and without performing the step for removal of microspheres. The reference junction was deployed in close (within 6 inches) proximity to the probe sensor. This allows for a more efficient determination of pulse to pulse energy fluctuations. A difference between the probe and reference polymer is that the reference polymer does not undergo the templating procedure which the probe polymer undergoes. This also acts as a barrier, protecting the reference junction from being influenced by interfering chemical species.

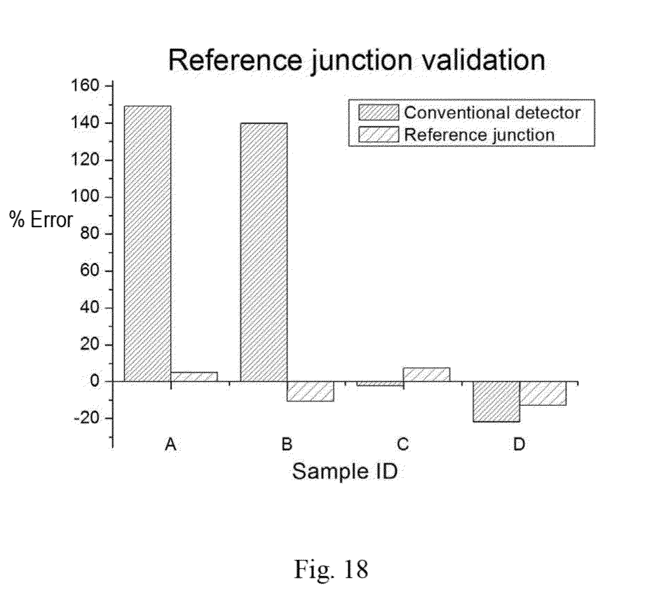

A series of samples, containing zinc in an acetate buffered solution and labeled A through D, were created in the lab and tested to verify that using a reference junction containing Dragon Green is more efficient than utilizing the fast photodiode detector located near the excitation source. Both reference systems were used to compensate for excitation intensity fluctuations. The concentrations for each sample were determined using a ratio of signal intensities between the probe junction signal and each reference system. FIG. 18 depicts the % error for each sample when determining the concentration against the true value, comparing the fast photodiode values versus the reference junction values. FIG. 18 demonstrates that utilizing the reference junction not only provides a more accurate sensor, constantly having a lower % error for all 4 samples, but also higher precision.

### Example 4

### Construction of a Dip Probe Sensor Element

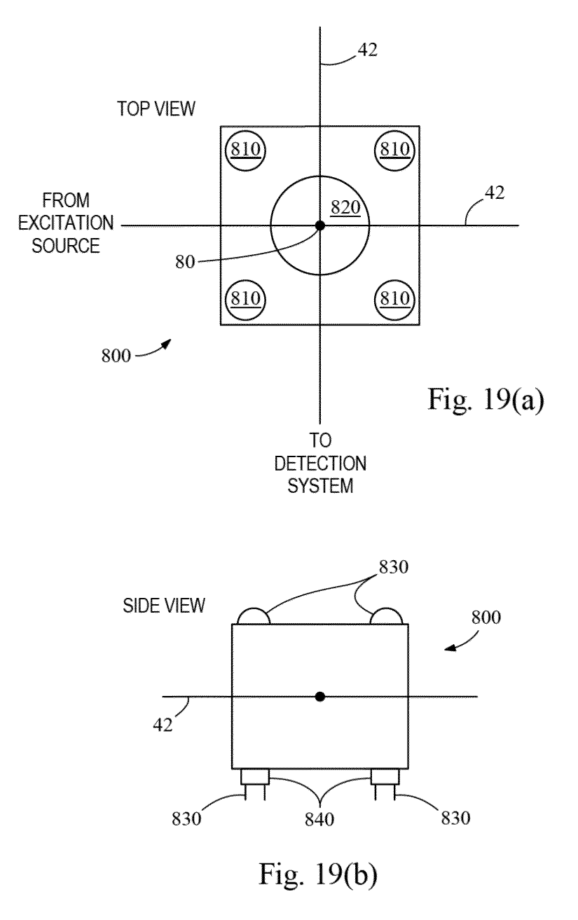

As shown in FIG. 19, a 1-in³ polypropylene block 800 was cut in half by bisecting four of the faces of the block. Four small holes 810 were drilled through both halves normal to the plane of the cut. Bolts 830 were threaded through these holes and secured with nuts 840 to hold the two halves together. A centered 0.5-inch hole 820 was drilled through the block as well. This allowed for transit of the analyte in solution to the probe sensor. Two optical fibers 42 were sandwiched between the two block halves with a junction 80 prepared according to Example 1 arranged within the main hole 820 of the polymer block 800. Both excitation and emission fibers fed into the fiber block. The blocks were required to provide structural support to the fibers. Without being limited by theory, it is believed that once the fiber cladding is removed, the glass cores were very fragile and the blocks provided structural support to prevent the fibers from breaking. While the probe polymer provided support to the fiber, the probe polymer is designed to keep the fibers in constant proximity in order to eliminate changes in the evanescent wave strength, not to prevent sensor breakage. These sensors blocks are easily transferable to from solution to solution and can be coupled to both excitation and detection equipment using standard fiber coupling devices.

### Example 5

### Construction of a Dip Probe Sensor Element with a Reference Junction

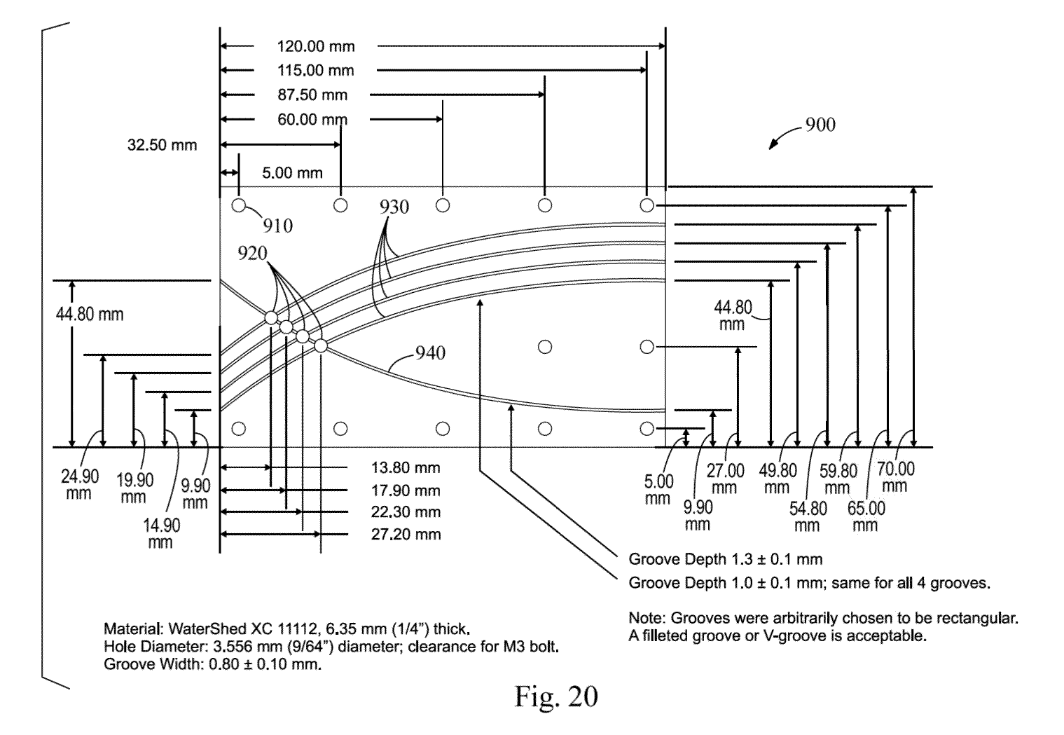

A first crossed-fiber dip probe mounting fixture 900 was prepared by machine fabrication, and the top-down view is shown in FIG. 20. A second crossed-fiber dip probe mounting fixture was prepared by machine fabrication, in a configuration which is a mirror image of the fixture shown in FIG. 20. The fixtures contained 12 assembly holes 910 (e.g. for bolts, screws, etc), 4 holes 920 that allow for exposure of sensor to the analyte, 1 groove for mounting the excitation fiber 930, 4 grooves for mounting the detection fiber(s) 940. The fixture can be designed with more grooves to accommodate additional fibers for building larger arrays. Also, the probe body can be further reduced in size.

Optical fibers as described in Example 1 above were placed into the groove for mounting the excitation fiber and two grooves for mounting the detection fiber in the first crossed-fiber dip probe mounting fixture. The second crossed-fiber dip probe mounting fixture is placed directly on top and in the same orientation and secured with M3 bolts to prevent the fibers from slipping out of the grooves, forming a waveguide retaining plate.

A first sensor junction was prepared according to the method of Example 1, substituting a Fluozin™-1 zinc(II) sensor for FAA. A reference junction was prepared according to Example 3 above.

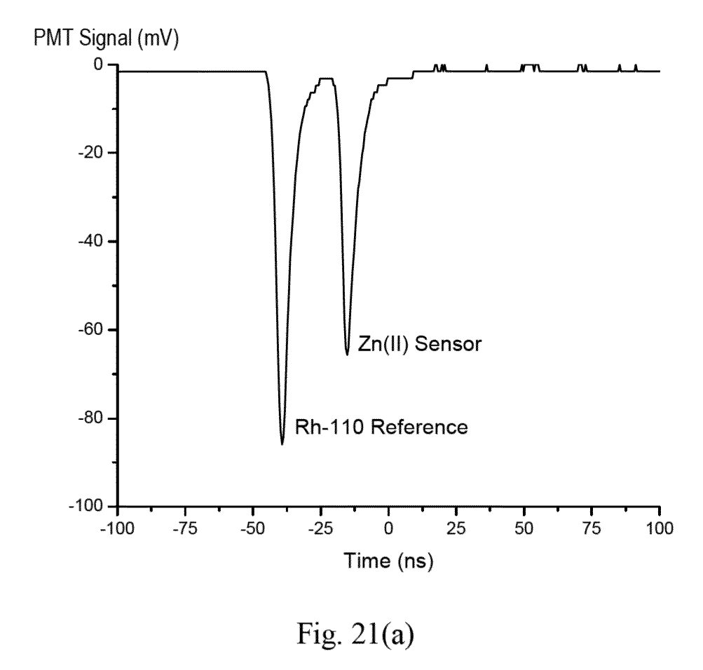

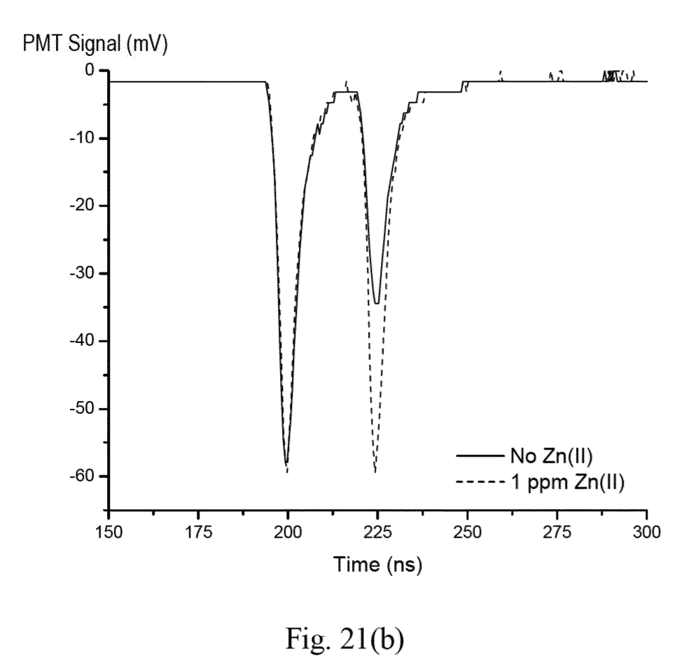

A sample waveform, shown in FIG. 21(a), was recorded after the microsphere dissolution step to verify the integrity of the sensor and reference chromophores. The waveform shown in FIG. 21(b) shows the reference and sensor intensities before and after exposure to 1 ppm Zn(II).

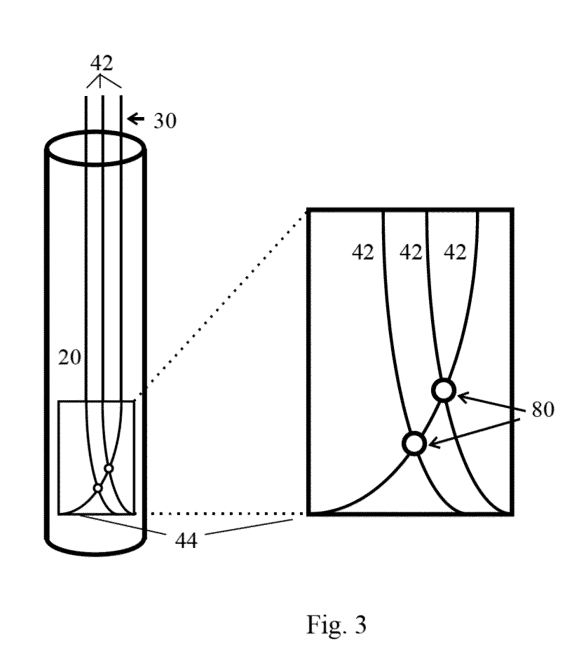

As shown in FIG. 3, an optical time of flight sensor array 20 is connected to a stem 30. In this embodiment, the optical time of flight sensor array contains 3 optical fibers 42. In this embodiment, two junctions 80 are prepared. In this embodiment, the optical time of flight sensor array 20 comprises a waveguide retaining plate 44 to restrict the movement of the optical fibers 42 relative to one another.

### Prophetic Example 6

### Luminescence-Lifetime-Based Sensing of Metals for Improved Quantification in the Presence of Interferents

As described earlier, to achieve spatially resolved readout, a pulsed-excitation source and optical time-of-flight detection (OTOFD) is employed. The circuitry described above serves to integrate the signal pulses, which are then converted to the concentrations of the analyte of interest via calibrations curves.

The use of OTOFD, however, allows for a different measurement mode, namely measurement of the sensor luminescence lifetimes, which are contained in the luminescence pulses arriving at the detector. For sensing of a single analyte, the signal is then a superposition of the characteristic luminescence decay of the sensor molecule with and without the analyte (requiring that both forms are in fact luminescent). As the concentration of the analyte increases, the relative weight of the bound signal increases; thus, the concentration information will be contained in the weighting factors (i.e. the amplitudes) of the respective species. Because luminescence-lifetime measurements are intensity-independent, they are inherently superior to intensity-based measurements. Under real-world conditions, intensity-based measurements require periodic calibration to account for instrumental fluctuations, such as noise, sensor degradation, photobleaching, sample turbidity, absorption and scattering effects, etc.

As described in Example 2, luminescence-lifetime-based sensing for an optical-fiber pH sensor was successfully implemented using both, stroboscopic (STD) and time-correlated single photon counting (TCSPC) detection. The dye used for these measurements, fluorescein, had two luminescent forms, monoanionic and dianionic, which were employed for the pH measurement. In spite of the fact that the luminescence lifetimes for these, 5.80 ns and 6.80 ns, respectively, only differed by 1 ns, the accuracy of this pH measurement surpasses that of a measurement made with pH electrodes.

In TCSPC, the emission of the sample is monitored through single photon events. The arrival times of single photons are measured precisely. Subsequently, these counts are binned into a histogram representing the luminescence decay of the sample over many excitation pulses. Some advantages of TCSPC are the highest available time resolution, sensitivity at the quantum level, and noise defined by Poisson statistics. Another time-domain luminescence lifetime technique is stroboscopic detection (STD). In this technique, the photomultiplier tube is configured in such a manner that photomultiplication only occurs over a fixed, narrow time window, typically 100 ps. Outside of this gate window, the detector is blind to incident light. Gate-window timing is precisely controlled by a digital delay generator (DDG) and the excitation-source trigger or a master-clock signal. At the desired time, the DDG triggers a high-voltage pulse that “strobes” the detector via a stripline circuit, and the resulting photocurrent is recorded. The decay curve is recorded by measuring the luminescent intensity as function of time as the gate window is moved in a boxcar fashion. In general, both methods allow for the determination of luminescence lifetimes that down to one tenth of the temporal width of the instrument response function.

The successful application of luminescence-lifetime-based sensing using a sensor dye with lifetimes below 10 ns and with a lifetimes difference of the two emissive forms of only 1 ns, suggests the use of these methods for sensing of metals. Required is a sensor dye that is luminescent both with and without bound analyte. This is the case for Fluozin™-1, which is used for sensing of Zn(II), for which it has the highest binding affinity. For some metals (e.g. Zn, Ni, Cd) the luminescence is enhanced (via photo-induced electron transfer), while others (e.g. Fe) mildly quench the luminescence. It is reasonable to assume that luminescence intensity differences manifest themselves in different lifetimes for different bound species.

Thus, for a single analyte, the total decay function of Fluozin™-1 is a superposition of the luminescence decays of Fluozin™-1 with bound Zn(II) and Fluozin™-1 without bound Zn(II), with the weight of each term (i.e. the amplitude factor) revealing the concentration of each form. While Fluozin™-1 is primarily a Zn sensor, it exhibits a somewhat lower sensitivity to other metals such as Cd, Ni, Pb, and Fe. It is reasonable to assume that the luminescence lifetime of Fluozin™-1 varies depending on which of these metals is bound to it. While the difference may be small, our capability of measuring—on optical fibers—lifetime differences in the sub-ns range will make this approach feasible.

This approach can be extended to the case when two metals, both of which can bind to Fluozin™-1, are present simultaneously. In this case, the total decay function will consist of three luminescence decays, i.e. that of Fluozin™-1 without any bound metal, Fluozin™-1 with bound metal 1 (e.g. Zn), and Fluozin™-1 with bound metal 2 (e.g. Cd). The lifetime of each species is known beforehand and is fixed for the fitting process, which leads to the determination of the amplitudes (i.e. weights of each term), which in turn reveals the concentrations of these species. Thus, this approach will allow for quantifying the effect of interferents on the primary measurement of a single analyte and, consequently, will greatly improve accuracy. In principle, this approach can be extended to the case where multiple metals are present; however, each additional metal adds more parameters to the fitting process of the total decay functions. If too many parameters have to be determined by the fitting process, there may no longer be a single unique set of parameters (e.g. the amplitudes), but multiple sets, all of which lead to a satisfactory fit.

The crossed-fiber sensor platform, however, allows for overcoming this issue by addition of sensor junctions to the array. While Fluozin™-1 is primarily a Zn sensor, with lower sensitivity to other metals such as Cd, Ni, Pb, and Fe, there are luminescent dyes which a primarily sensitive to these interferences (e.g. Newport Green DCF for Ni, with minor sensitivity to Zn and others). One such sensor will be added to array, and the signals from Fluozin™-1 and the added sensor will be combined with the goal of extracting from the total array response more accurate concentrations for Zn and for one or more interferents, effectively increasing the specificity of the array for multiple metals.

Depending on the sensor molecule, luminescence lifetimes may depend on temperature and on pH. Separate sensor junctions can be added to the fiber-sensor platform for measuring pH and temperature using luminescence lifetimes. The temperature sensor dye can be encapsulated in a polymer to prevent the analyte from reaching it; the pH sensor can be attached to a matrix containing nanoengineered channels for a rapid response to pH changes.

Finally, should oxygen quench the luminescence of the metal-sensor dyes, a separate sensor junction for luminescence-lifetime-based measurement of dissolved-oxygen concentration can be added to the array, which allows for correcting the response of the metal-sensor-dyes, thereby improving accuracy.

The luminescence-lifetime measurement approach described here is not restricted to the sensors described here, but is applicable to optical fiber sensors for many different sensing tasks.

### REFERENCES

Ábalos T, Jiménez D, Martínez-Máñez R, Ros-Lis J V, Royo S, Sancenón F, et al. Hg²⁺ and Cu²⁺ Selective Detection using a Dual Channel Receptor based on Thiopyrylium Scaffoldings. Tetrahedron Letters. 2009; 50(27):3885-3888.
Akpor O B, Muchie M. Remediation of Heavy Metals in Drinking Water and Wastewater Treatment Systems Processes and Applications. International Journal of the Physical Sciences. 2010; 5(12):1807-17.
Anzenbacher P, Tyson D S, Jursikova K, Castellano F N. Luminescence Lifetime-Based Sensor for Cyanide and Related Anions. Journal of the American Chemical Society. 2002; 124(22):6232-3.
Arbeloa I L 1981 Dimeric and trimeric states of the fluorescein dianion—part 1 J. Chem. Soc., Perkin Trans. 2 77 1725-33.
Arbeloa I L 1981 Dimeric and trimeric states of the fluorescein dianion—part 2 J. Chem. Soc., Perkin Trans. 2 77 1735-42.
Ayres D M, Davis A P, Gietka P M. Removing Heavy Metals from Wastewater: University of Maryland—Engineering Research Center Report; 1994.
Becker W 2006 The Becker-Hickl TCSPC Handbook 2nd edn (Berlin: Becker and Hickl GmbH)
Bistricki T, Munawar M. Application of X-ray Microanalysis for the Detection of Heavy Metals in Great Lakes Alge. Canadian Journal of Fisheries and Aquatic Sciences. 1982; 39(3):506-9.
Browne C A, Tarrant D H, Olteanu M S, Mullens J W, Chronister E L. Intrinsic Sol-Gel Clad Fiber-Optic Sensors with Time-Resolved Detection. Analytical Chemistry. 1996; 68(14):2289-95.
Demas J N, DeGraff B A. Design of Luminescence Based Temperature Sensors.
Chemical, Biochemical, and Environmental Fiber Sensors IV; 1992; Boston, Mass.: Proceedings of SPIE.
Dodani S C, He Q, Chang C J. A Turn-On Fluorescent Sensor for Detecting Nickel in Living Cells. Journal of the American Chemical Society. 2009; 131(50):18020-18021.
Draxler S and Lippitsch M E 1996 Lifetime-based sensing: influence of the microenvironment Anal. Chem. 68 753-7.
Draxler S et al 1995 Effects of polymer matrixes on the time-resolved luminescence of a ruthenium complex quenched by oxygen J. Phys. Chem. 99 3162-7.
Gao J, Wang P and Giese R W 2002 Xanthanide fluorescent dyes Anal. Chem. 74 6397-401.
Grinvald A and Steinberg I Z 1974 On the analysis of fluorescence decay kinetics by the method of least-squares Anal. Biochem. 59 583-98.
Hach, Products for Water Analysis, 2006.
Hambidge K M, Krebs N F. Zinc Deficiency: A Special Challenge. The Journal of Nutrition. 2007; 137(4):1101-5.
He Q, Miller E W, Wong A P, Chang C J. A Selective Fluorescent Sensor for Detecting Lead in Living Cells. Journal of the American Chemical Society. 2006; 128(29):9316-9317.
Henning P E, Benko A, Schwabacher A W, Geissinger P, Olsson R J. Apparatus and Methods for Optical Time-of-Flight Discrimination in Combinatorial Library Analysis. Review of Scientific Instruments. 2005; 76:0622201-8.
Hill S J, editor: Inductively Coupled Plasma Spectrometry and its Applications. Wiley-Blackwell; 2007.
Irvin J A, Quickenden T I and Sangster D F 1981 Criterion of goodness of fit for deconvolution calculations Rev. Sci. Instrum. 52 191-4.
James D R, Siemiarczuk A and Ware W R 1992 Stroboscopic optical boxcar technique for the determination of fluorescence lifetimes Rev. Sci. Instrum. 63 1710-6.
Johnson I, Spence M T Z (eds.): Molecular Probes Handbook. Invitrogen; 11 ed., 2011. ISBN-10: 0982927916.
Kopitzke S, Geissinger P. Milwaukee: University of Wisconsin—Milwaukee; 2011.
Köse M E, Carroll B F, Schanze K S. Preparation and Spectroscopic Properties of Multiluminophore Luminescent Oxygen and Temperature Sensor Films. Langmuir. 2005; 21(20):9121-9.
Kürner J M, Klimant I, Krause C, Preu H, Kunz W, Wolfbeis O S. Inert Phosphorescent Nanospheres as Markers for Optical Assays. Bioconjugate Chemistry. 2001; 12(6):883-9.
Kvasnik F, McGrath AD, editors. Distributed Chemical Sensing Utilizing Evanescent-Wave Interactions. Chemical, Biochemical, and Environmental Fiber Sensors; 1989; Boston, Mass.: Proceedings of the SPIE.
Leonhardt H, Gordon L and Livingston R 1971 Acid-base equilibria of fluorescein and 2,7-dichlorofluorescein in their ground and fluorescent states J. Phys. Chem. 76 245-9.
Lieberman R A, Blyler L L, Cohen L G. A Distributed Fiber Optic Sensor based on Cladding Fluorescence. Journal of Lightwave Technology. 1990; 8(2):212-20.
Lippitsch M E, Draxler S, Leiner M J. Time-Domain Fluorescence Methods as Applied to pH Sensing. Chemical, Biochemical, and Environmental Fiber Sensors IV; 1992; Boston, Mass.: Proceedings of the SPIE.
Ma J and Bock W J 2007 Dramatic performance enhancement of evanescent-wave multimode fiber fluorometer using non-Lambertian light diffuser Opt. Express 15 16457-70.
Manahan S E. Hazardous Waste Chemistry, Toxicology and Treatment: Lewis Publishers; 1990.
Martin M M and Lindqvist L 1975 The pH dependence of fluorescein fluorescence J. Lumin. 10 381-90.
McKinnon A E, Szabo A G and Miller D R 1977 The deconvolution of photoluminescence data J. Phys. Chem. 81 1564-70.
Molecular Probes Handbook, 11th edition, 2011.
Munkholm C et al 1986 Polymer modification of fiber optic chemical sensors as a method of enhancing fluorescence signal for pH measurement Anal. Chem. 58 1427-30
Muralidhara H S. Solid/Liquid Separation: Waste Management and Productivity Enhancement: Battlle Press; 1990.
Niemczyk T M, Ettiger D G and Barnhart S G 1979 Optimization of parameters in photon counting experiments Anal. Chem. 51 2001-4.
Nishimura G and Tamura M 2005 Artefacts in the analysis of temporal response functions measured by photon counting Phys. Med. Biol. 50 1327-42.
Noiseux I, Long W, Cournoyer A, Vernon M. Simple Fiber-Optic-Based Sensors for Process Monitoring An Application in Wine Quality Control Monitoring. Applied Spectroscopy. 2004; 58(8):1010-9.
Nollet, Leo. Handbook of Water Analysis, CRC press; 2007.
Ocean Optics, 2011. http://www.oceanoptics.com/products/sensors.asp.
O'Connor D V, Ware W R and Andre J C 1979 Deconvolution of fluorescence decay curves. A critical comparison of techniques J. Phys. Chem. 83 1333-43.
Orte A, Crovetto L, Talayera E M, Boens N, Alvarez-Pez J M. Absorption and Emission Study of 2′,7′-Difluorofluorescein and its Excited-State Buffer-Mediated Proton Exchange Reactions. Journal of Physical Chemistry A. 2005; 109(5):734-47.
Park S H, Xia Y. Macroporous Membranes with Highly Ordered and Three-Dimensionally Interconnected Spherical Pores. Advanced Materials. 1998; 10(13):1045-8.
Pask C and Snyder A W 1976 Multimode optical fibers: interplay of absorption and radiation losses Appl. Opt. 15 1295-8.
Peng X, Du J, Fan J, Wang J, Wu Y, Zhao J, et al. A Selective Fluorescent Sensor for Imaging Cd²⁺ in Living Cells. Journal of the American Chemical Society. 2007; 129(6):1500-1501.
Potyrailo R A, Hieftje G M. Optical Time-of-Flight Chemical Detection: Spatially Resolved Analyte Mapping with Extended-Length Continuous Chemically Modified Optical Fibers. Analytical Chemistry. 1998; 70(8):1453-61.
Prince B J, Kaltcheva N T, Schwabacher A W, Geissinger P. Fluorescent Fiber-Optic Sensor Arrays Probed Utilizing Evanescent Fiber-Fiber Coupling. Applied Spectroscopy. 2001; 55(8):1018-24.
Prince B J, Schwabacher A W, Geissinger P. A Readout Scheme Providing High Spatial Resolution for Distributed Fluorescent Sensors on Optical Fibers. Analytical Chemistry. 2001; 73:1007-15.
Rigo M V, Olsson R J, Geissinger P. Crossed-Optical-Fiber Oxygen Sensors with Intensity and Temperature Referencing for Use in High-Spatial-Resolution Sensor Arrays. Sensors and Transducers. 2010; 113(2):18-32.
Sakata K, et al Inventors; Inductively Coupled Plasma Mass Spectrometer and Method. U.S. Pat. No. 6,265,717. 2001; Jul. 24, 2001.
Skoog D A, West D M, Holler F J. Fundamentals of Analytical Chemistry. Fort Worth: Saunders College Publishers; 1992.
Sloan, W. D. and Uttamlal, M., “Immobilization of fluorescein on optical fibres,” in Sensors and Their Applications VIII, A. T. Augousti and N. M. White, Eds., pp. 275-279,
Smith S A and Pretorius W A 2002 Spectrophotometric determination of pKa values for fluorescein using activity coefficient corrections Water SA 28 395-405 Institute of Physics Publishing, Glasgow, UK, 1997.
Spectrecology, 2011. http://www.spectrecology.com/Oxygen_Sensors.php
Schwabacher A W, Geissinger P, Inventors; Wisys Technology Foundation, Inc., Assignee. One-Dimensional Arrays on Optical Fibers. U.S. Pat. No. 7,244,572. 2007 Jul. 7, 2007.
United States Environmental Protection Agency “Technologies and Techniques for Early Warning Systems to Monitor and Evaluate Drinking Water Quality: A State-of-the-Art Review”; EPA/600/R-05/156; August, 2005; pp 77.
Wallace P A et al. 2001 Development of a quasi-distributed optical fibre pH sensor using a covalently bound indicator Meas. Sci. Technol. 12 882-6.
Wang D, Williams C G, Li Q, Sharma B, Elisseeff J H. Synthesis and Characterization of a Novel Degradable Phosphate-Containing Hydrogel. Biomaterials. 2003; 24(22):3969-80.
Weiner E R. Application of Environmental Chemistry, A Practical Guide for Environmental Professionals Lewis Publishers; 2000.
Wolfbeis OS. Fiber-Optic Chemical Sensors and Biosensors. Analytical Chemistry. 2004; 76(12):3269-84.
Zeng L, Miller E W, Pralle A, Isacoff E Y, Chang C J. A Selective Turn-On Fluorescent Sensor for Imaging Copper in Living Cells. Journal of the American Chemical Society. 2005; 128(1):10-11.

What is claimed is:

1. A sensor element for determining the concentration of an analyte in a liquid suspected of containing said analyte comprising:
an optical time of flight sensor array;
a stem; and
a control interface,
wherein the optical time of flight sensor array comprises a first waveguide comprising an excitation terminus located at a first end of the first waveguide, a second waveguide comprising a signal terminus located at a first end of the second waveguide, and at least one junction,
wherein at least one junction is a probe junction comprising a probe polymer and a probe compound,
wherein said probe compound is a luminescent compound that produces a first optical signal in the absence of the analyte and a second optical signal in the presence of the analyte, wherein said first optical signal and second optical signal have different peak signal intensity, different integrated signal intensity, different signal decay rate, different signal wavelength, or a combination thereof,
wherein the stem is connected to the control interface via a control end and to the optical time of flight sensor array via an array end, and
wherein the control interface comprises an excitation control interface and a signal control interface.

2. The sensor element of claim 1, further comprising a waveguide retaining plate, wherein the waveguide retaining plate restricts movement of the first and second waveguide relative to one another at each junction.

3. The sensor element of claim 1, wherein the array comprises from 2 to 1,000,000 junctions.

4. The sensor element of claim 1, wherein the analyte is selected from the group consisting of metal ions, non-metal ions, electrically neutral species, chemical compounds, proteins, sugars, lipids, amines, aromatic compounds, opiates, alcohols, polynucleotides, biological and chemical warfare agents, and combinations thereof,
wherein the probe compound is selected from the group consisting of luminescent chromophores, quantum dots, nanoparticles, nanostructures, and combinations thereof, and wherein the probe compound comprises a probe compound signal time of from about 1 ps to about 1 ms, a probe compound recovery time of from about 1 ps to about 1 s, or a probe compound detection time of from about 1 ms to about 20 minutes.

5. The sensor element of claim 1, wherein said probe polymer is a porous polymer, and wherein said probe polymer comprises a poly(ethylene)glycol diacrylate polymer.

6. The sensor element of claim 1, wherein at least one junction adjacent to said probe junction is a reference junction comprising a reference polymer and a reference compound,
wherein the reference junction is located on the first waveguide within 1 m of the probe junction,
wherein the reference compound is a luminescent compound that produces a reference optical signal having a peak signal intensity, an integrated signal intensity, a signal decay rate, or a combination thereof that varies with respect to an excitation radiation intensity at said probe junction and that remains unchanged in the presence or absence of the analyte,
wherein the reference compound comprises a reference compound signal time of from about 1 ps to about 1 ms, a reference compound recovery time of from about 1 ps to about 1 s, or a reference compound detection time of from about 1 ms to about 20 minutes,
wherein the reference compound is selected from the group consisting of luminescent chromophores, microspheres containing luminescent chromophores, nanoparticles, and combinations thereof, and
wherein the reference polymer is a sufficiently nonporous polymer selected from the group consisting of polystyrene, polyacrylonitrile, PEGDA with sufficient crosslink density, and combinations thereof.

7. The sensor element of claim 1, wherein the stem is from about 1 μm to about 100 km in length and allows independent orientation for the optical time of flight sensor array relative to the control interface, and wherein the stem is adapted to provide optical coupling between the excitation control interface and the excitation terminus and between the signal control interface and the signal terminus, and
wherein the stem is adapted to conduct radiation with a loss of intensity of less than about 99.9%, or wherein the stem is adapted to conduct radiation with a pulse broadening of less than about 1000% as measured by full-width at half-maximum of an intensity profile.

8. The sensor element of claim 1, wherein the sensor element is adapted to be used as a dip probe.

9. An apparatus for determining the concentration of an analyte in a liquid suspected of containing said analyte comprising:
the sensor element of claim 1, and
a control unit comprising
a light source;
a detector;
a signal processing device; and
a sensor interface,
wherein the light source emits a pulsed electromagnetic radiation suitable for use in optical time of flight spectroscopy,
wherein the light source, the detector and the signal processing device are electronically coupled,
wherein the sensor interface comprises an excitation sensor interface and a signal sensor interface,
wherein the light source and the excitation sensor interface are optically coupled, and
wherein the detector and the signal sensor interface are optically coupled.

10. The apparatus of claim 9, wherein the pulsed electromagnetic radiation has an average wavelength from about 300 nm to about 2000 nm, an average full duration at half maximum pulse duration from about 1 fs to about 100 ns, and a repetition rate from about 1 Hz to about 100 MHz,
wherein the light source comprises a pulsed light-emitting diode, a pulsed laser, a pulsed lamp, a pulsed laser diode, or a pulsed microchip laser,
wherein the detector is capable of detecting optical time of flight spectroscopy signals, and
wherein the detector is selected from the group consisting of photomultiplier tube, hybrid photomultiplier tube, charge-coupled device, avalanche photodiode, multi-channel plate, photodiode arrays, and combinations thereof.

11. The apparatus of claim 9, wherein the apparatus is adapted to be handheld.

12. An apparatus for determining the concentration of an analyte in a liquid suspecting of containing the analyte comprising:
an optical time of flight sensor array;
a light source;
a detector; and
a signal processing device,
wherein the optical time of flight sensor array comprises a first waveguide comprising an excitation terminus located at a first end of the first waveguide, a second waveguide comprising a signal terminus located at a first end of the second waveguide, and at least one junction,
wherein at least one junction is a probe junction comprising a probe polymer and a probe compound,
wherein said probe compound is a luminescent compound that produces a first optical signal in the absence of the analyte and a second optical signal in the presence of the analyte, wherein said first optical signal and second optical signal have different peak signal intensity, different integrated signal intensity, different signal decay rate, different signal wavelength, or a combination thereof,
wherein the light source, the detector and the signal processing device are electronically coupled,
wherein the light source and the excitation terminus are optically coupled, and
wherein the detector and the signal terminus are optically coupled.

13. The apparatus of claim 12, further comprising a waveguide retaining plate, wherein the waveguide retaining plate restricts movement of the first and second waveguide relative to one another at each junction.

14. The apparatus of claim 12, wherein the array comprises from 2 to 1,000,000 junctions.

15. The apparatus of claim 12, wherein the analyte is selected from the group consisting of metal ions, non-metal ions, electrically neutral species, chemical compounds, proteins, sugars, lipids, amines, aromatic compounds, opiates, alcohols, polynucleotides, biological and chemical warfare agents, and combinations thereof,
wherein the probe compound is selected from the group consisting of luminescent chromophores, quantum dots, nanoparticles, nanostructures, and combinations thereof, and
wherein the probe compound comprises a probe compound signal time of from about 1 ps to about 1 ms, a probe compound recovery time of from about 1 ps to about 1 s, or a probe compound detection time of from about 1 ms to about 20 minutes.

16. The apparatus of claim 12, wherein said probe polymer is a porous polymer, and wherein said probe polymer comprises a poly(ethylene)glycol diacrylate polymer.

17. The apparatus of claim 12, wherein at least one junction adjacent to said probe junction is a reference junction comprising a reference polymer and a reference compound,
wherein the reference junction is located on the first waveguide within 1 m of the probe junction,
and wherein the reference compound is a luminescent compound that produces a reference optical signal having a peak signal intensity, an integrated signal intensity, a signal decay rate, or a combination thereof that varies with respect to an excitation radiation intensity at said probe junction and that remains unchanged in the presence or absence of the analyte,
wherein the reference compound comprises a reference compound signal time of from about 1 ps to about 1 ms, a reference compound recovery time of from about 1 ps to about 1 s, or a reference compound detection time of from about 1 ms to about 20 minutes,
wherein the reference compound is selected from the group consisting of luminescent chromophores, microspheres containing luminescent chromophores, nanoparticles, and combinations thereof, and
wherein the reference polymer comprises polystyrene, polyacrylonitrile, PEGDA with sufficient crosslink density, and combinations thereof.

18. The apparatus of claim 12, further comprising a stem,
wherein the stem is from about 1 μm to about 100 km in length and allows independent orientation for the optical time of flight sensor array relative to the light source or detector, and wherein the stem is adapted to provide optical coupling between the light source and the excitation terminus and between the signal terminus and the detector,
wherein the stem is adapted to conduct radiation with a loss of intensity of less than about 99.9%, or wherein the stem is adapted to conduct radiation with a pulse broadening of less than about 1000% as measured by full-width at half-maximum of an intensity profile.

19. The apparatus of claim 12, wherein the apparatus is adapted to be used as a dip probe.

20. The apparatus of claim 12, wherein the pulsed electromagnetic radiation has an average wavelength from about 300 nm to about 2000 nm, an average full duration at half maximum pulse duration from about 1 fs to about 100 ns, and a repetition rate from about 1 Hz to about 100 MHz,
wherein the light source comprises a pulsed light-emitting diode, a pulsed laser, a pulsed lamp, a pulsed laser diode, or a pulsed microchip laser,
wherein the detector is capable of detecting optical time of flight spectroscopy signals,
wherein the detector is selected from the group consisting of photomultiplier tube, hybrid photomultiplier tube, charge-coupled device, avalanche photodiode, multi-channel plate, photodiode arrays, and combinations thereof.

21. The apparatus of claim 12, wherein the apparatus is adapted to be handheld.
